(19) United States
(12) Patent Application Publication
(10) Pub. No.: US 2026/0010828 A1
(43) Pub. Date: Jan. 8, 2026

(54) SYSTEM AND METHOD FOR MONITORING WITH ARTIFICIAL INTELLIGENCE

(71) Applicant: Musyfy Inc., Mississauga (CA)

(72) Inventor: Sarbjit S. PARHAR, Mississauga (CA)

(21) Appl. No.: 19/029,167

(22) Filed: Jan. 17, 2025

Related U.S. Application Data
(60) Provisional application No. 63/667,639, filed on Jul. 3, 2024.

(51) Int. Cl. G06N 20/00

(52) U.S. Cl. CPC G06N 20/00

(57) ABSTRACT

Aspects of the present application relate to a method for monitoring performance of equipment, the method include: collecting, at a mobile device, sensed data from a noise sensor, wherein the noise sensor is configured to monitor the equipment; receiving, at a machine learning model, the sensed data; and receiving, from the machine learning model, a prediction of the performance of the equipment; and displaying the prediction on a graphical user interface. The method may further include determining the prediction includes a prediction of poor performance, and displaying the prediction on the graphical user interface may further include generating, in response to the determination, an alert for the prediction.

### CROSS-REFERENCE TO RELATED APPLICATIONS

This application claims priority to U.S. Provisional Patent Application No. 63/667,639, entitled “Architectural Framework, Design, and Development of a Unified Application Capable of the Artificial Narrow Intelligence, Artificial General Intelligence and Artificial Super Intelligence”, which was filed Jul. 3, 2024, the contents of which are incorporated herein by reference.

### FIELD

This invention pertains to an architecture for artificial intelligence, and particular to applications to analytics, planning and monitoring.

### BACKGROUND

Existing artificial intelligence (AI) solutions may include, for example, demand prediction and image classification. However, these AI solutions may be limited to specific and narrow applications. In particular, these AI solutions may be limited to solving problems only within a single domain, and a different AI solution may be required to solve a problem in another domain. As well, the development of these AI solutions is often custom, cumbersome and time-consuming. As well, although generative AI solutions do exist, these are not integrated into a unified system with other AI solutions.

### SUMMARY

Example embodiments may provide methods and systems for analytics, planning and monitoring using artificial intelligence.

According to at least one embodiment, there is disclosed a method for monitoring performance of equipment, the method including: collecting, at a mobile device, sensed data from a noise sensor, wherein the noise sensor is configured to monitor the equipment; receiving, at a machine learning model, the sensed data; and receiving, from the machine learning model, a prediction of the performance of the equipment; and displaying the prediction on a graphical user interface.

In some embodiments, the method may further include determining the prediction includes a prediction of poor performance, and displaying the prediction on the graphical user interface further includes generating, in response to the determination, an alert for the prediction.

In some embodiments, displaying the prediction on the graphical user interface may further include generating a custom visualization based on the prediction.

In some embodiments, the method may further include collecting, at the mobile device, the sensed data from at least one of a noise sensor, a vibration sensor, a temperature sensor, a relative humidity sensor, a gyroscope, a magnetometer, a global positional system (GPS) device, a microphone, a vision, a light sensor, a vibration sensor, a harshness sensor, a pressure sensor, a current sensor, a carbon dioxide sensor, a water leakage sensor, a passive infrared (PIR) sensor, a magnetic door sensor, a soil sensor, an air quality sensor, a volatile organic compounds sensor or a particulate matter sensor.

In some embodiments, the sensed data from the noise sensor may further include noise data in the inaudible range for humans.

In some embodiments, the method may further include pre-processing the sensed data and receiving, at the machine model, the pre-processed sensed data.

In some embodiments, the machine learning model may be re-trained on at least one of the sensed data, the prediction of the performance, or new sensed data collected after the prediction is received from the machine learning model.

In some embodiments, the method may further include servicing the equipment or automatically adjusting the equipment in response to the prediction of poor performance.

In some embodiments, the prediction of poor performance may be at least one of a prediction of failure of the equipment, a prediction of mean time between failures (MTBF) of the equipment, a prediction of required maintenance of the equipment, a prediction for automatically adjusting operational parameters of the equipment, or a prediction of the health of the equipment.

In some embodiments, the method may further include installing the noise sensor on the equipment and connecting the noise sensor to the mobile device.

In some embodiments, the noise sensor may be integrated within the mobile device.

In some embodiments, the noise sensor may be a microphone of the mobile device.

In some embodiments, the sensed data may be continuously collected from the noise sensor.

In some embodiments, displaying the prediction on the graphical user interface may further include generating a report summarizing the performance of the equipment over a period of time based on the continuously collected sensed data.

In some embodiments, the equipment may be located in at least one of a heating, ventilation and air conditioning (HVAC) unit, a manufacturing plant, a cement plant, a transportation vehicle, a retail environment, a telecommunications facility, a mine, agriculture equipment, a residential facility, or a warehouse.

In some embodiments, the machine learning model may be hosted in a cloud computing environment, and the sensed data may be transmitted from the mobile device to the cloud computing environment over a network for inference.

In some embodiments, the machine learning model may be executed on the mobile device, and the inference may be performed on-device without transmitting the sensed data to an external server.

In some embodiments, a first portion of the machine learning model may be executed on the mobile device and a second portion may be executed in a cloud computing environment, such that partial inference occurs on-device and final inference occurs on the cloud computing environment.

According to at least one embodiment, there is disclosed a system for monitoring performance of equipment, the system including: a memory; at least one processor to: collect, at a mobile device, sensed data from a noise sensor, wherein the noise sensor is configured to monitor the equipment; receive, at a machine learning model, the sensed data; and receive, from the machine learning model, a prediction of the performance of the equipment; and display the prediction on a graphical user interface.

In some embodiments, the at least one processor may be further configured to determine the prediction includes a prediction of poor performance, and wherein displaying the prediction on the graphical user interface may further include generating, in response to the determination, an alert for the prediction.

In some embodiments, displaying the prediction on the graphical user interface further may include generating a custom visualization based on the prediction.

In some embodiments, the at least one processor may be further configured to collect, at the mobile device, the sensed data from at least one of a noise sensor, a vibration sensor, a temperature sensor, a relative humidity sensor, a gyroscope, a magnetometer, a global positional system (GPS) device, a microphone, a vision, a light sensor, a vibration sensor, a harshness sensor, a pressure sensor, a current sensor, a carbon dioxide sensor, a water leakage sensor, a passive infrared (PIR) sensor, a magnetic door sensor, a soil sensor, an air quality sensor, a volatile organic compounds sensor or a particulate matter sensor.

In some embodiments, the sensed data from the noise sensor may further include noise data in the inaudible range for humans.

In some embodiments, the at least one processor may be further configured to pre-process the sensed data and receive, at the machine model, the pre-processed sensed data.

In some embodiments, the machine learning model may be re-trained on at least one of the sensed data, the prediction of the performance or new sensed data collected after the prediction is received from the machine learning model.

In some embodiments, the at least one processor may be further configured to service the equipment or automatically adjust the equipment in response to the prediction of poor performance.

In some embodiments, the prediction of poor performance may be at least one of a prediction of failure of the equipment, a prediction of mean time between failures (MTBF) of the equipment, a prediction of required maintenance of the equipment, a prediction for automatically adjusting operational parameters of the equipment, or a prediction of the health of the equipment.

In some embodiments, the noise sensor may be installed on the equipment and connected to the mobile device.

In some embodiments, the noise sensor may be integrated within the mobile device.

In some embodiments, the noise sensor may be a microphone of the mobile device.

In some embodiments, the sensed data may be continuously collected from the noise sensor.

In some embodiments, displaying the prediction on the graphical user interface may further include generating a report summarizing the performance of the equipment over a period of time based on the continuously collected sensed data.

In some embodiments, the equipment may be located in at least one of a heating, ventilation and air conditioning (HVAC) unit, a manufacturing plant, a cement plant, a transportation vehicle, a retail environment, a telecommunications facility, a mine, agriculture equipment, a residential facility, or a warehouse.

In some embodiments, the at least one processor may be configured to perform inference in a cloud computing environment, and wherein the mobile device transmits the sensed data to the cloud computing environment for analysis.

In some embodiments, the at least one processor may be configured to perform inference on the mobile device, such that the machine learning model resides on the mobile device.

In some embodiments, the at least one processor may be distributed between an edge device and a cloud computing server, and the instructions may cause partial preprocessing on the edge device prior to transmitting the preprocessed data to the cloud computing server for generating the prediction.

According to at least one embodiment, there is disclosed one or more non-transitory computer readable media storing computer-executable instructions thereon that, when executed by at least one computer, cause the at least one computer to perform a method including: collecting, at a mobile device, sensed data from a noise sensor, wherein the noise sensor is configured to monitor the equipment; receiving, at a machine learning model, the sensed data; and receiving, from the machine learning model, a prediction of the performance of the equipment; and displaying the prediction on a graphical user interface.

### BRIEF DESCRIPTION OF DRAWINGS

Reference will now be made, by way of example, to the accompanying drawings which show example embodiments, and in which:

FIG. 1 is a block diagram of a system incorporating an analytics engine, according to some example embodiments;

FIG. 2 is a block diagram of an example artificial intelligence agent;

FIG. 3 is a schematic of the analytics engine of FIG. 1, according to some embodiments;

FIGS. 4A-4B are another schematic of the analytics engine of FIG. 1, according to other embodiments;

FIG. 5 is a block diagram of an environment in the system of FIG. 1;

FIG. 6 is a flow diagram of a decision tree performed by the analytics engine of FIG. 1, according to some example embodiments;

FIG. 7 is another flow diagram of another decision tree performed by the analytics engine of FIG. 1, according to other example embodiments;

FIG. 8 is a block diagram of another system incorporating an analytics engine, according to some example embodiments;

FIG. 9 is a block diagram of input in the system of FIG. 8;

FIG. 10 is a block diagram of the analytics engine of FIG. 8, according to some example embodiments;

FIG. 11 is a block diagram of AI agents in the analytics engine of FIG. 10;

FIG. 12 is a block diagram of an example business overview generated by the analytics engine of FIG. 10;

FIG. 13 is a block diagram of an example business plan generated by the analytics engine of FIG. 10;

FIGS. 14-18 are methods for generating a business plan using the system of FIG. 8, according to some example embodiments;

FIG. 19 is a block diagram of another system incorporating an analytics engine, according to some example embodiments;

FIG. 20 is a block diagram of an example sensor package in the system of FIG. 19;

FIG. 21 is a block diagram of the analytics engine of FIG. 19, according to some example embodiments;

FIGS. 21-23 are methods for predicting the performance of equipment using the system of FIG. 19, according to some example embodiments; and

FIG. 24 is a block diagram of a computing device, according to an example embodiment.

### DETAILED DESCRIPTION

### Analytics Engine

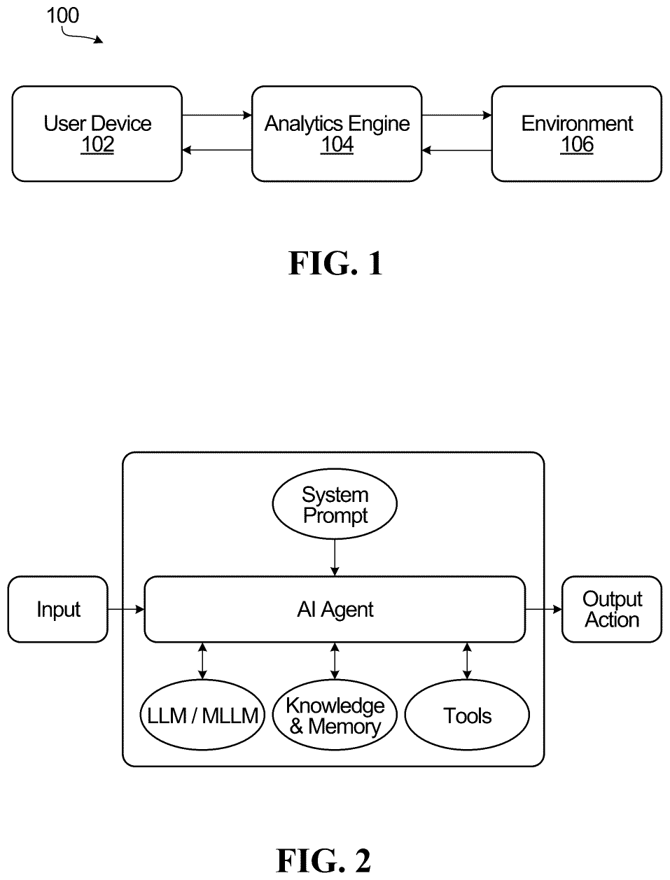

FIG. 1 depicts a system 100, which includes a user device 102, an analytics engine 104 and an environment 106.

User device 102 may a computing device, such as a mobile device, a personal computer, a server, an embedded system or some other device with computing capabilities. User device 102 may receive input from a user, such as a human, or from another computing device, such as one or more sensors, equipment and/or information systems.

User device 102 communicates with analytics engine 104, such as over a network (not depicted). User device 102 and analytics engine 104 may exchange information with one another, such that user device 102 may both transmit information to and receive information from analytics engine 104. The network may include the Internet, an intranet, a WiFi network, a Bluetooth network, an iBeacon network, or some other communication protocol which allows user device 102 and analytics engine 104 to exchange information.

In some implementations, analytics engine 104 may be executed, hosted and/or stored on a server, multiple servers or some other computing device(s). In these implementations, cloud computing may be used to allow user device 102 to communicate with analytics engine 104.

In some implementations, analytics engine 104 or portions of analytics engine 104 may be executed, hosted and/or stored on user device 102. In these implementations, edge computing or a combination of edge computing and cloud computing may be used to allow user device 102 to communicate with analytics engine 104. In the implementations where only a portion of analytics engine 104 is executed, hosted and/or stored on user device 102, analytics engine 104 contained on user device 102 may communicate with the portion of analytics engine 104 executed, hosted and/or stored on a server or some other external computing device.

Analytics engine 104 may also communicate with environment 106, such as over a network (not depicted). Examples of a network may include the Internet, an intranet, a WiFi network, a Bluetooth network, an iBeacon network or some other communication protocol. Analytics engine 104 may query environment 106, send data to environment 106, retrieve data from environment 106 and respond to queries from environment 106. Analytics engine 104 and environment 106 may communicate bidirectionally, similar to user device 102 and analytics engine 104. As will be discussed in further detail below, environment 106 may include databases, the Internet, such as websites, application specific interfaces (APIs), computing devices, sensors, an intranet, internal systems, etc.

Analytics engine 104 may be used to process data, generate analytics insights based on data, respond to queries received from input device 102, automate tasks and processes, and/or solve problems.

In some implementations, analytics engine 104 may provide a unified application capable of embodying Artificial Narrow Intelligence (ANI), Artificial General Intelligence (AGI), and Artificial Super Intelligence (ASI). Analytics engine 104 may be used by an organization or user of user device 102 to engineer artificial intelligence (AI) solutions and task automation.

ANI may also be known as weak AI. ANI may refer to AI that is specialized in a specific task or a narrow range of tasks. A key characteristic of ANI may a solution which is task specific, limited in scope, and without any true understanding. However, ANI may be more efficient than humans, in some examples.

AGI may be capable of understanding, learning and performing any intellectual task that a human can perform.

ASI may go further than AGI by exceeding human capabilities in every domain. ASI may create self-driven goals and/or objectives.

AGI and ASI may be capable of solving a vast array of problems across multiple domains, exhibiting versatility and adaptability. Some problems AGI and ASI may solve include complex decision-making, multitasking across domains, autonomous innovation, enhanced efficiency and productivity, improved personalization and solving global challenges.

Currently, AGI and ASI may be theoretical and elusive concepts. While ANI exists, its development may often be custom, cumbersome, and time-consuming. System 100 and analytics engine 104 may offer a streamlined solution capable of addressing and solving any problem efficiently across the spectrum of AI capabilities.

For example, existing technologies may include disparate ANI solutions such as demand prediction models, image classification models, etc. These solutions may often be limited to specific, narrow applications. Additionally, generative AI solutions like GPT-4, Gemini 1.5, and Llama 3 are available but may not be integrated into a unified system that encompasses ANI, AGI, and ASI.

In some implementations, analytics engine 104 may also include a team of AI agents. As used herein, an AI agent may include at least one AI model, such as a large language model (LLM) or multi-model large language model (MLLM). An AI agent may also include one or more other models or tools to allow AI agent to perform one or more tasks. Furthermore, as used herein, the terms AI agent and intelligent agent may also be used to refer to a single AI agent or one or more AI agents, such as a group of AI agents which may collaborate to solve problems.

An example AI agent is depicted in FIG. 2, which may include an LLM or MLLM, knowledge and memory, and tools. The AI agent may input. In some examples, the AI agent may also include a system prompt. The AI agent may generate an output action based on the input, the LLM/MLLM, knowledge and memory, and/or system prompt.

In some examples, an AI agent may be a computational entity designed to perform tasks by perceiving inputs, processing information, and executing actions to achieve specific goals. At its core, the AI agent may include an LLM or an MLLM, which may serve as the brain of the AI agent, enabling input data and processing understanding, contextual reasoning, and decision-making. The AI agent may be equipped with tools such as task-specific APIs, plugins, or computational modules, which may extend the capabilities of the AI agent beyond language processing to include data retrieval, numerical analysis, and/or automated workflows. The AI agent may receive inputs through various connections, including natural language commands, structured data (e.g., tables or databases), sensory data (e.g., audio, video, or environmental metrics), and external APIs for real-time information. These inputs may be preprocessed in a processing layer to ensure context-aware decision-making. The AI agent may produce output actions that range from generating natural language responses to executing tasks via APIs, controlling physical devices, and/or delivering data insights and visualizations. To improve continuously, the AI agent may integrate a feedback loop and learning mechanisms, leveraging user feedback, logged interactions, and/or reinforcement learning to refine its performance over time.

As already discussed briefly above, implementations of system 100 may include cloud, edge, and both cloud and edge computing. For example, in some implementations of cloud computing, edge computing, and both cloud and edge computing, predicative AI, generative AI and an agentic framework with a team of AI agents may be used. These implementations may be used to achieve ANI/AGI/ASI.

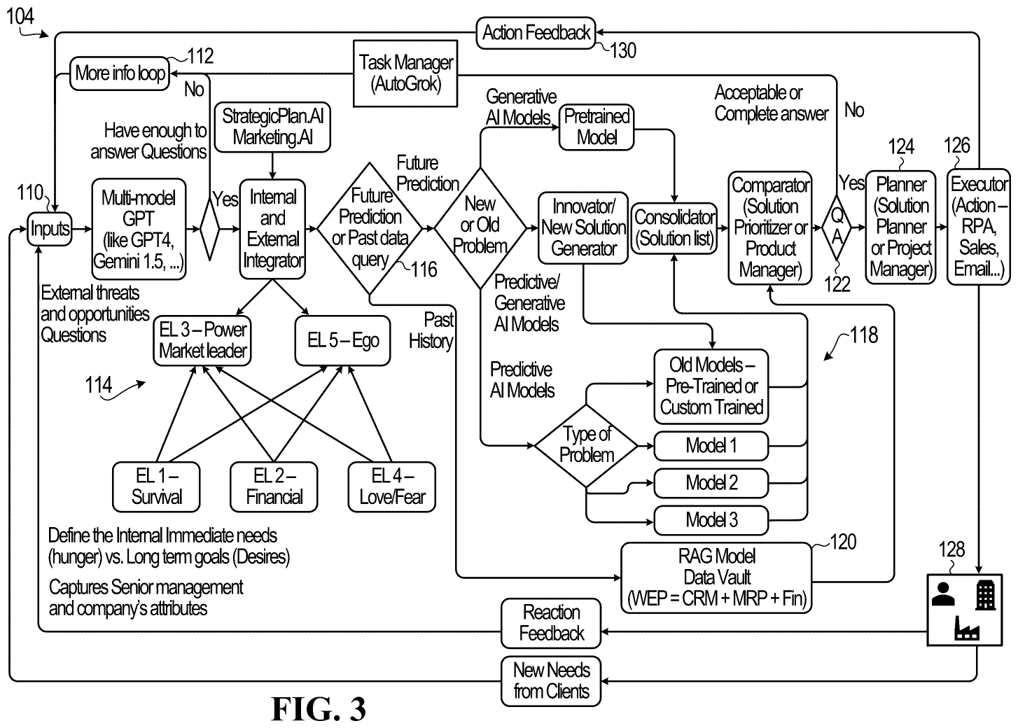

FIG. 3 depicts a schematic of analytics engine 104, according to some implementations.

Analytics engine 104 includes inputs 110, which may be received from user device 102 and/or environment 106. Inputs 110 may include information, data, queries, prompts, problems to be solved and/or other input. Inputs 110 may be in the form of text, images, videos, a stream, documents and/or some other data format.

In some implementations, inputs 110, which may include data and/or one or more prompts, may be passed on to every step of analytics engine 104 discussed below. Passing inputs 110 to every step may allow every step in analytics engine 104 to decide if any portion of inputs 110 is relevant to that step, and this may reduce time for analytics engine 104 to respond to inputs 110. Steps in analytics engine 104 may include AI agents and/or LLMs in analytics engine 104, which are discussed in further detail below.

Analytics engine 104 may also include more information loop 112. At more information loop 112, analytics engine 104 may determine whether inputs 110 is sufficient for analytics engine 104 to provide a result, solution or answer, such as an answer to a query or a solution to a problem. If inputs 110 is not sufficient, such as if more information or data is required, more information loop 112 may request more information, data and/or other input at inputs 110.

Analytics engine 104 may also include AI agents 114. In some implementations, AI agents 114 may define the internal immediate needs (hunger) versus long term goals (desires) of an organization, business or some other entity. For example, AI agents 114 may capture the attributes of senior management in an organization/company and the company itself.

Analytics engine 104 may include a decision point 116, which may determine whether inputs 110 relate to future prediction or a query related to past history. Decision point 116 may connect to a future prediction module 118 if inputs 110 relate to future prediction. Decision point 116 may instead connect to a past history query module 120 if inputs 110 relate to a query of past history. In some examples, decision point 116 may connect to both future prediction module 118 and past history query module 120, such as in examples where inputs 110 relate to both future prediction and a query related to past history.

Future prediction module 118 may assess whether a problem specified by inputs 110 is a new problem or an old problem. Depending on whether the problem is new or old, a pretrained model may be used, which may be a generative AI model or models. As well, if the problem is old, the type of problem may be identified and one or more old, pre-trained or custom trained models may be used. If the problem is new, predictive and/or generative AI models may be used to generate or select one or more pre-trained or old models. In some examples, multiple problems may be included in inputs 110 and/or a single problem may require multiple models, and so the outputs of multiple models may be consolidated into a solution list at future prediction module 118.

Past history query module 120 may include a retrieval-augmented generation (RAG) model and/or data vault. Past history query module 120 may also include resources for enterprise resource planning (ERP), including resources customer relationship management (CRM), material requirements planning and financials.

Analytics engine 104 may also include comparator 122. At comparator 122, an output solution or solutions from one or both of future prediction module 118 and past history query module 120 may be assessed to determine if the solution or solutions provide an acceptable or complete answer to the problem or queries included within inputs 110. If the solution or solutions are not acceptable or complete, comparator 122 may loop back to an earlier stage within analytics engine 104 to repeat or refine the solution generation process, such as by requiring more data or information at inputs 110. If the solution or solutions are acceptable or complete, comparator 122 may proceed.

As a precursor to execution, analytics engine 104 may also include planner 124, which may include a solution planner or project manager. Planner 124 may break down the solution into smaller steps, if needed, before execution. Planner 124 may include the solution or solutions from comparator 122.

Analytics engine 104 may also include executor 126, which may perform actions based on planner 124. Actions may include a computer action like sending emails, performing or coordinating sales, robotic process automation (RPA), etc.

Analytics engine 104 may communicate with environment 106, as already discussed above. In some examples, environment 106 may include company infrastructure, systems, computing devices, vendors, websites, etc. Executor 126 may perform actions to environment 106. Analytics engine 104 may also receive feedback from external feedback mechanism 128, which may be connected to company or organization infrastructure, such as within environment 106. Feedback may include reaction feedback, new needs from clients (e.g. clients of the company or organization or the organization itself) or other forms of feedback. This feedback may be fed back into inputs 110, which may be used in another process loop of analytics engine 104 or considered for further processing.

In addition, action feedback 130 may be generated by executor 126 for analytics engine 104 to feed into inputs 110 on a subsequent process loop or consider for further processing.

It will be understood that other implementations and examples of analytics engine 104 may also be possible. Some or all of the modules or stages discussed above within analytics engine 104 may be rearranged, removed or replaced, and new or other modules not discussed so far may also be included within analytics engine 104.

Analytics engine 104 may integrate predictive AI, generative AI, and agentic AI workflows. As will be discussed further below, analytics engine 104 may employ a team of AI agents alongside a phone application for data input (e.g. user device 102). This computation may then be executed in the cloud, on edge devices, and/or a combination of both.

Data Integration and Sources: Analytics engine 104 may connect AI agents to various data sources, such as ERP, CRM and financial systems (e.g. within environment 106). Analytics engine 104 may facilitate seamless data flow and AI configuration. Data may also be collected from noise, vibration, harshness (NVH), global positioning system (GPS), voice, and vision sensors embedded in a phone, such as a phone providing input to analytics engine 104 (e.g. user device 102). This data may be used for training custom models or for real-time inferencing to predict future outcomes.

Holistic Application Functionality: Analytics engine 104 may enable comprehensive analysis by examining historical data to answer questions about past events. Predictions may be generated using pre-trained and/or custom-trained models, which may be deployed either in the cloud or on edge devices.

Feedback Loop and Continuous Improvement: A feedback loop may be integrated in analytics engine 104 for handling unsolved or partially solved problems. Even fully resolved issues may remain open until the corresponding reactions or outcomes are recorded, which may ensure continuous improvement and accuracy.

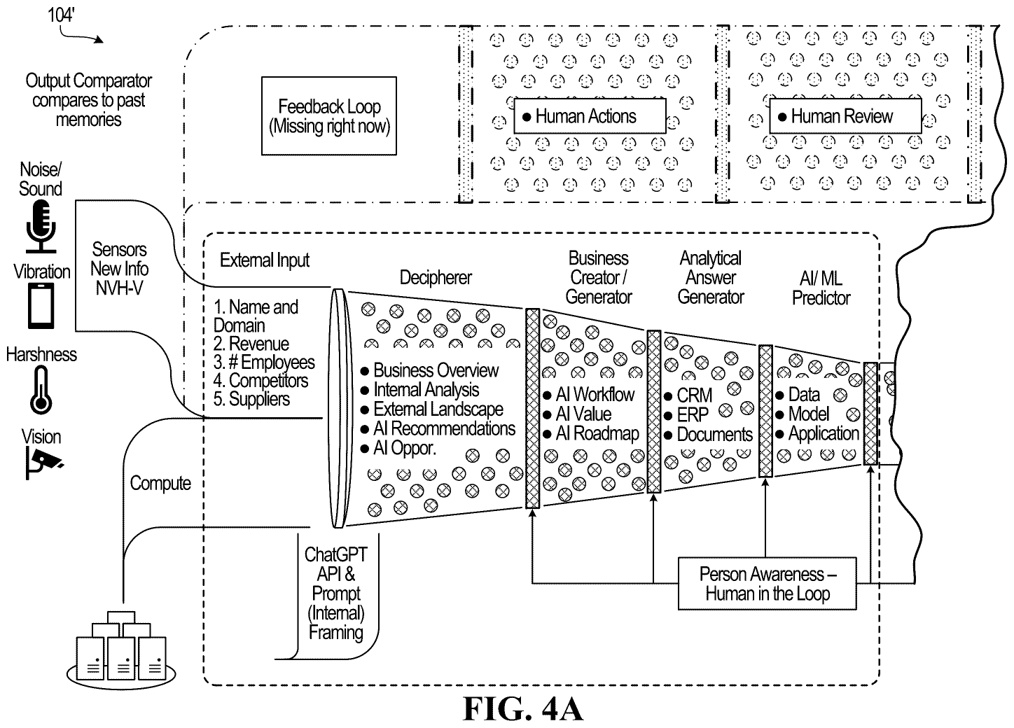

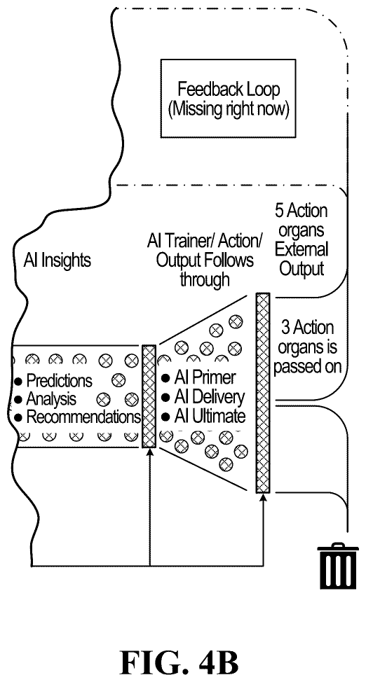

FIGS. 4A-4B depict an analytics engine 104′, according to some other implementations of analytics engine 104. It will be understood that analytics engine 104 and analytics engine 104′ may be interchangeable in system 100, and all reference to analytics engine 104 as used herein may also refer to analytics engine 104′.

Analytics engine 104′ may receive external input. In some examples, external input may include sensor information and new information. Sensor information may include noise/sound, vibration, harshness and vision (NVH-V) information.

In further examples, external input may also or instead include information describing a company, such as name and domain information, revenue of the company, a number of employees at the company, competitors of the company, customers of the company and suppliers of the company.

External input may also or instead include computation data and/or prompt data. Prompt data may be parsed by a large language model, such as by an API, e.g. the ChatGPT™ API.

Analytics engine 104′ may include a decipherer external input. Decipherer may generate a business overview, internal analysis, external landscape, AI recommendations and/or AI opportunities identified by analytics engine 104′. Decipherer may also store its inputs and outputs in a memory of analytics engine 104′.

It will be appreciated that memory and awareness may be important determinants in decision making. Memory may be akin to weights and biases in a pre-trained AI model. Awareness may be akin to a processor. Memory and awareness may be found in reinforcement learning from human feedback (RLHF), which may be human awareness laced and may benefit from a good pre-trained model.

Analytics engine 104′ may also include a business creator/generator, which may generate an AI workflow, AI value and/or AI roadmap. Business creator/generator may also store its inputs and outputs in a memory of analytics engine 104′.

Analytics engine 104′ may also include an analytical answer generator, which may receive and/or generate CRM, ERP and documents. Analytical answer generator may also store its inputs and outputs in a memory of analytics engine 104′.

Analytics engine 104′ may also include an AI/machine learning (ML) predictor, which may receive and/or generate data, models and software applications. AI/ML predictor may also store its inputs and outputs in a memory of analytics engine 104′. As used herein, the term artificial intelligence (AI) also includes machine learning.

Analytics engine 104′ may also generate AI insights, which may include predictions, analysis and/or recommendations. AI insights may also be stored in a memory of analytics engine 104′.

Analytics engine 104′ may also include an AI trainer and/or may perform actions our output.

Action organs and external output may be passed on in a feedback loop, as well as with human actions to the output. The feedback loop may include a comparator, which compares the output to past memories, e.g. the memories of analytics engine 104′. The feedback loop may return to the input and also be fed into analytics engine 104′ as external input. In other examples, the output may be discarded by analytics engine 104′.

It will be understood that other implementations and examples of analytics engine 104′ may also be possible. Some or all of the modules or stages discussed above within analytics engine 104′ may be rearranged, removed or replaced, and new or other modules not discussed so far may also be included within analytics engine 104′.

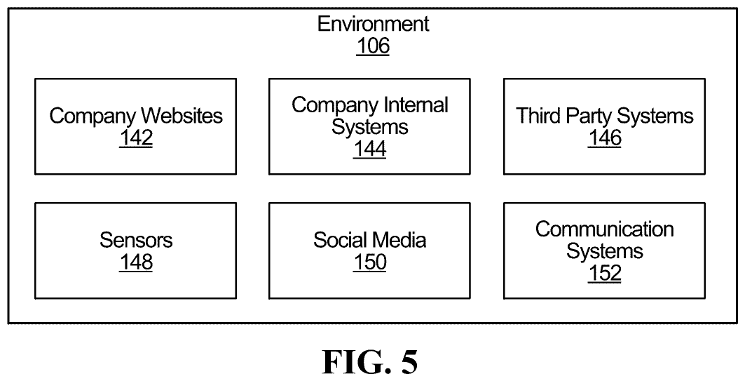

FIG. 5 depicts environment 106, according to some implementations. Environment 106 may include company websites 142, company internal systems 144, third party systems 146, sensors 148, social media 150 and communication systems 152.

Company websites 142 may include the websites of the company or organization using analytics engine 104, such as a company associated with user device 102. Company websites 142 may also include the websites of suppliers and/or competitors.

Company internal systems 144 may include financial systems, records, company databases, employee information, email and messaging systems, and/or company software, as well as other internal systems.

Third party systems 146 may include APIs, machinery/robotics software and hardware interfaces, the systems of other organizations, financial institutions, news websites and/or software, as well as other systems.

Sensors 148 may include discrete hardware sensors, sensors integrated into a mobile device or equipment, software sensors, sensors accessible through a third-party interface, such third party systems 146, etc. Examples of sensors may include microphones, gyroscopes, temperature sensors, cameras, etc.

Social media 150 may include X™ (formerly Twitter™), Facebook™, Instagram™, Reddit™, news websites, and other social media platforms which may allow an organization to market a product, initiative or service.

Communication systems 152 may include email, texting, messaging, telephone, video conference and other systems allowing a company to communicate with external organizations.

Environment 106 may include fewer or more of the systems, networks and modules discussed above, and may also include other systems, networks and modules not discussed or depicted.

Environment 106 may also generally include the Internet, an intranet, networked devices, Internet-of-Things (IoT) devices and systems, WiFi networked systems, Bluetooth networked systems, iBeacon networked systems, as well as other networked systems and services.

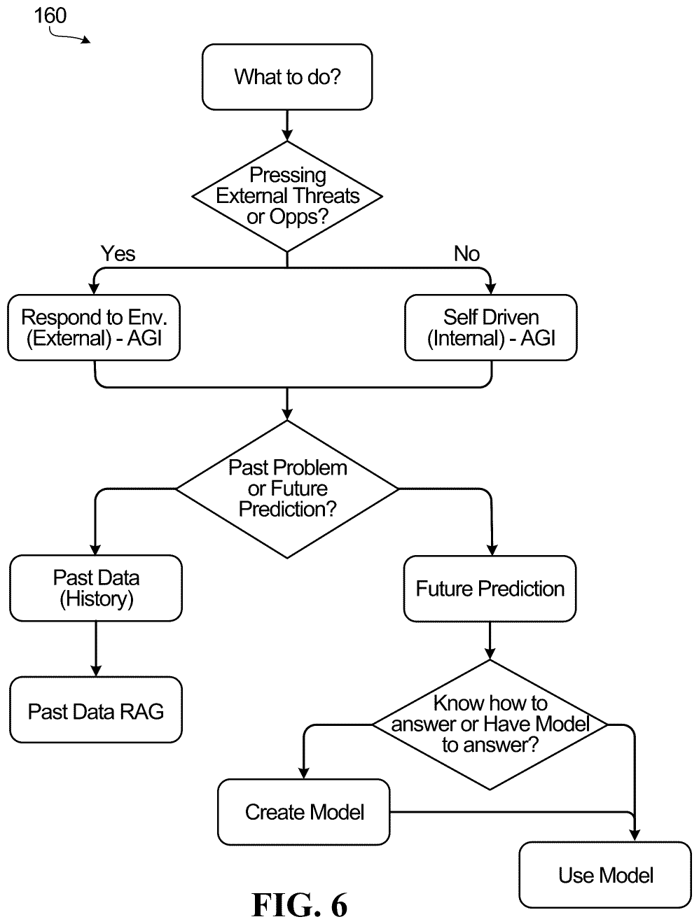

FIG. 6 depicts a decision tree 160 which may be executed by analytics engine 104 to determine what to do to solve a problem or answer a query, according to some implementations.

For example, analytics engine 104 may be presented with a query or problem. Analytics engine 104 may first determine whether the query is a pressing external threat or an opportunity. If the threat is pressing, analytics engine 104 may respond to the environment (e.g. environment 106) using AGI. If the threat is not pressing, analytics engine 104 may responds with a self-driven solution, such as by using ASI.

Analytics engine 104 may next determine whether the problem is a past problem or a future prediction problem. If the problem is a past problem, past data (history) may be used, and analytics engine 104 may use a past data RAG. Answers may be based on the past.

If the problem is a future prediction problem, then future prediction may be used. In some examples, future prediction may include learning from observing and creating new models, akin to how humans make mental models.

Analytics engine 104 may determine whether it knows how to answer the problem/future prediction or has a model to answer the problem. If analytics engine 104 does not have a model, analytics engine 104 may create a model and use the created model to solve/answer the problem. However, if analytics engine 104 already has a model, it will use the existing model to answer/solve the problem. Answers may be based on the predictions from these new models.

Analytics engine 104 may also create new goals, e.g. self-driven objectives. These new goals may be based on past data (e.g. history). These new goals may also or instead be based on future prediction, as described above.

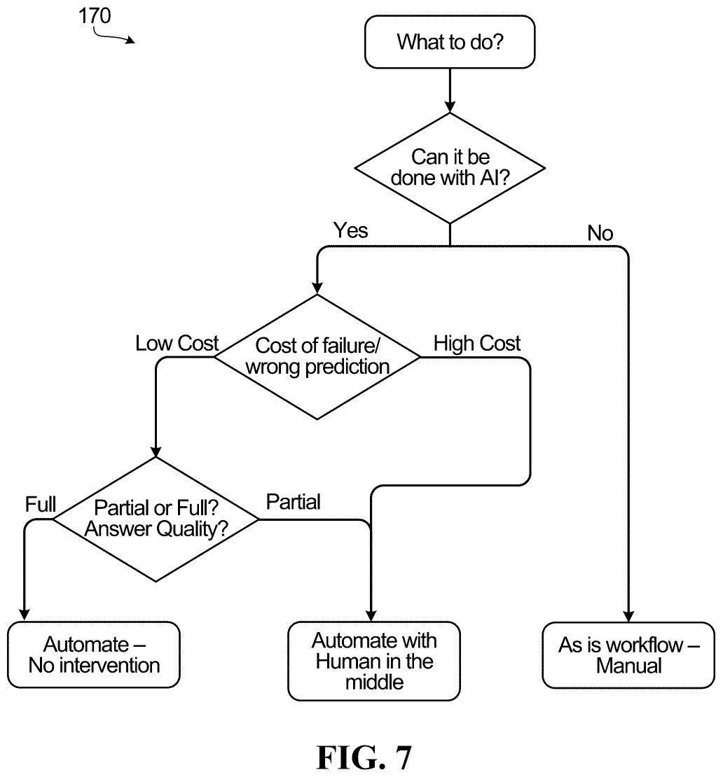

FIG. 7 depicts another decision tree 170 which may be executed by analytics engine 104 to determine what to do to solve a problem or answer a query, according to other implementations.

In previous workflows, problems may have been solved with an as-is workflow, i.e. a manual workflow. However, decision tree 170 depicts a process which may consider the cost of failure or a wrong prediction before determining whether a fully automated solution (e.g. no human intervention), a partially automated solution (e.g. with a human in the middle), or an as-is workflow (e.g. manual, human directed and/or no automation) is appropriate to solving a problem or completing a task. Decision tree 170 may also determine whether the problem or task can be solved/completed with AI.

One challenge related to autonomous ANI, AGI and ASI solutions may include determining when to stop iterations for solving a problem or completing a task. One possible solution to this challenge may include calculating the AI value from each task automation. In some examples, analytics system 104 and/or analytics system 104′ may be applied to business applications. In these examples, basic inputs about the organization may be recorded, such as business name, website, revenue, employees. Tasks may be determined, and approximations of time spent in hours per year and cost (rate per hour), inventory turn, machine downtime using AI, etc., may be determined. If possible, tasks may be validated, e.g. time and cost, inventory turns and machine downtime in actual reality. The value (e.g. benefit) of automation using AI and analytics may also be calculated. Iterations on automation of different tasks may be repeated until all this possible is completed. Industry benchmarks may also be used as a guide.

### Business Applications

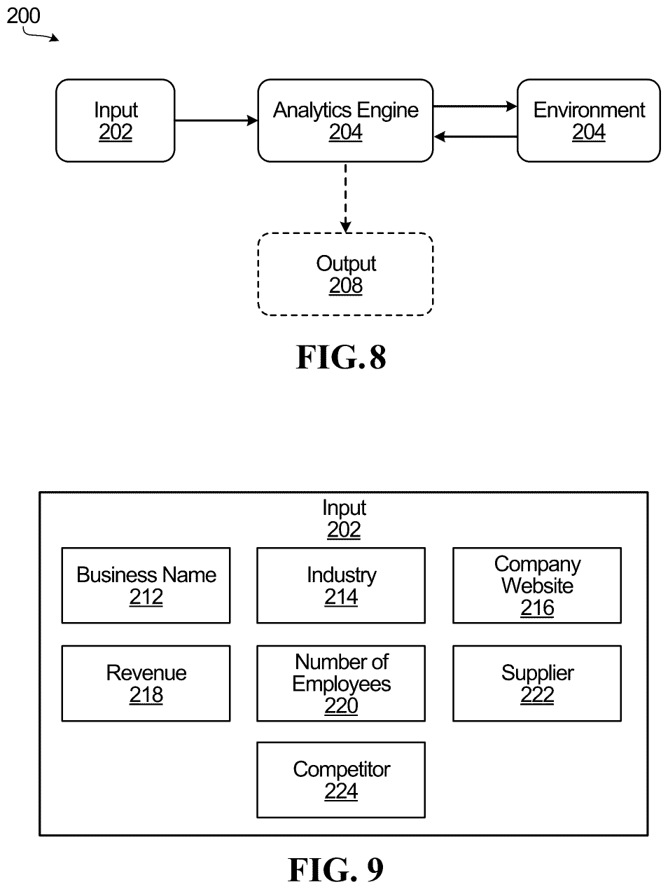

FIG. 8 depicts a system 200, which may be used to determine a business plan. System 200 includes an input 202, an analytics engine 204 and environment 106. System 200 may also include an output 208. System 200 may be used by a company or business. As used herein, the terms company, business and organization are used interchangeably.

Input 202 may be provided by user device 102 to analytics engine 204. In other implementations, a different computing device or system may provide input 202. Similarly, output 208 may also be provided from analytics engine 204 to user device 102 or, in other implementations, to a different computing device or system.

Input 202 may include details describing a business, such as a business associated with user device 102, as depicted in FIG. 9. For example, input 202 may include a business name 212, an industry 214 associated with the business, a company website 216, revenue 218 associated with the business, a number of employees 220 who work for or worked for the company, a supplier 222 to the business, a competitor 224 of the business, and/or customers of the business (not depicted). Input 202 may include some or all of these details describing the business. Input 202 may also or instead include other information about the business.

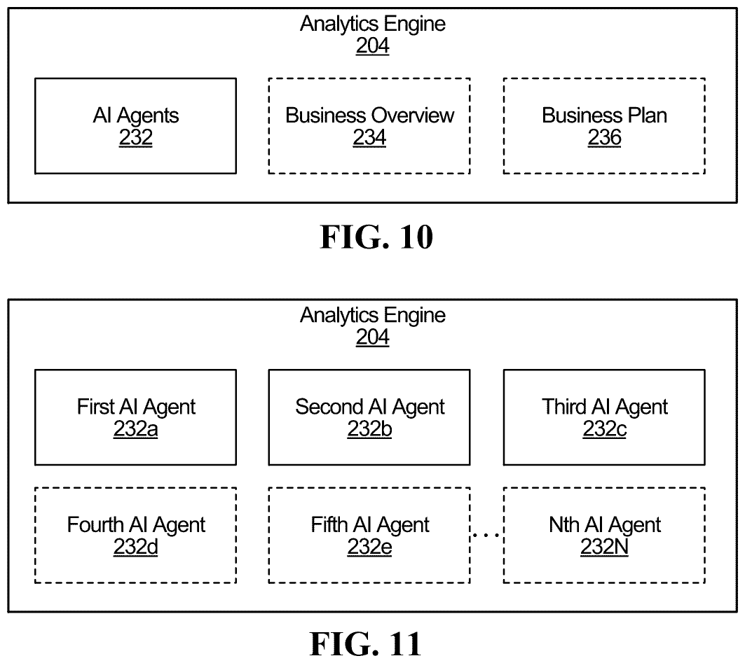

Analytics engine 204 may be the same or substantially similar to analytics engine 104 and/or analytics engine 104′. For example, FIG. 10 depicts analytics engine 204, according to some implementations. Analytics engine 204 includes AI agents 232. Analytics engine 204 may also include a business overview 234 and a business plan 236. It will be understood that analytics engine 204 may include fewer or more modules or components than analytics engine 104 and/or analytics engine 104′. Analytics engine 204 may also or instead include other modules or components in addition to or instead of existing modules or components in analytics engine 104 and/or analytics engine 104′.

AI agents 232 may be the same or similar to AI agents 114 depicted in FIG. 2 and/or FIG. 3. AI agents 232 may include a plurality of agents, such as a first AI agent 232a, a second AI agent 232b and a third AI agent 232c, as depicted in FIG. 11. AI agents 114 may also include a fourth AI agent 232d and a fifth AI agent 232e. In some implementations, AI agents 232 may include up to N AI agents, including an Nth AI agent 232N.

As used herein, an AI agent may refer to a single AI agent, which may include an LLM or MLLM with a model or tool used to perform one or more tasks for analytics engine 204. An AI agent may also refer to a group of AI agents which may be used to perform one or more tasks for analytics engine 204. Thus, the terms AI agent and group of AI agents may be used interchangeably herein.

Analytics engine 204 may generate business overview 234 and/or business plan 236, such as by using AI agents 232. Business overview 232 may be generated based on input 202. Business plan 236 may be generated based on business overview 234 and/or input 202.

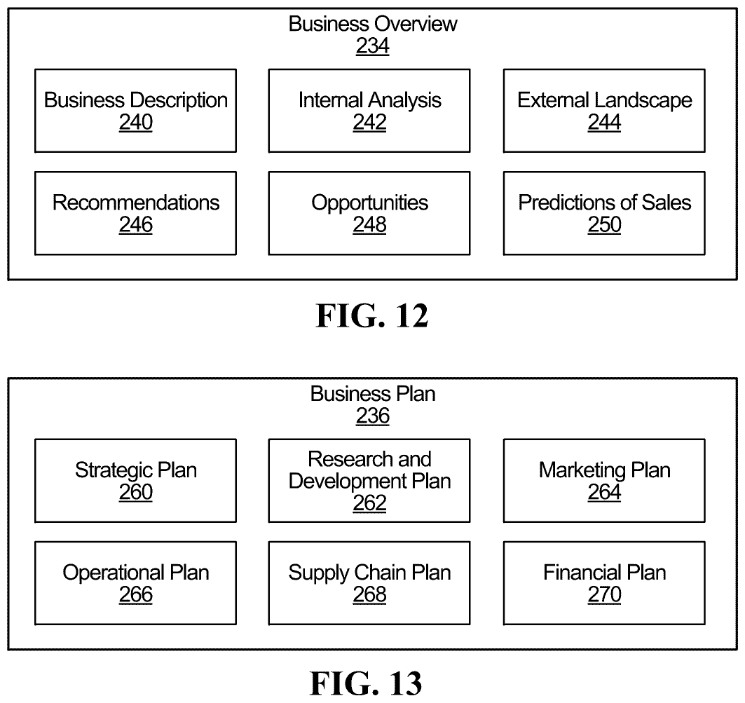

FIG. 12 depicts business overview 234, according to some examples. In some examples, business overview 234 may summarize or include some or all of input 202. In other examples, business overview 234 may be generated based on input 202 and using AI agents 232.

Business overview 234 may include a business description 240, which may describe the business provided by input 202. For example, business description 240 may include a summary of the business generated by AI agents 232, including a summary of other elements included within business overview 234. Business description 240 may also include at least one of business name 212, industry 214, company website 216, revenue 218, number of employees 220, supplier 222 and/or competitor 224. Business description 240 may also include a customer of the business.

Business overview 234 may also include internal analysis 242, which may summarize an analysis of the business's internal operations, financials, manufacturing, inventory, etc. Internal analysis 242 may be generated by AI agents 242.

Business overview 234 may also include external landscape 244, which may summarize competitors of the business, technological developments in the relevant industry, historical and/or future customer demand, growth sectors, etc. External landscape 244 may also be generated by AI agents 242.

Business overview 234 may further include recommendations 246. In some examples, recommendations 246 may include recommendations generated by AI agents 222 for improving the business, such as recommendations for incorporating AI and/or automation into the business. Recommendations 246 may also include a prediction of sales, revenue gain, cost efficiencies or some other improvement as a result of incorporating AI and/or automation into the business, e.g. cost savings for the business from following the recommendation(s).

In addition, business overview 234 may also include opportunities 248, which may include opportunities for growth, investment, research and development, expansion, improvement and/or automation which the business may wish to explore. Opportunities 248 may include other opportunities not listed but which may lead to cost savings, growth, synergy or some other advantage to the business. It will be appreciated that opportunities 248 may overlap with recommendations 246, and recommendations 246 may include recommendations for pursuing certain of opportunities 248. For example, opportunities 248 may indicate certain aspects of the business in which AI and/or automation may be used to improve the business. Opportunities 248 may be generated by AI agents 232.

Similarly, business overview 234 may also include prediction of sales 250, which may also overlap with recommendations 246 and/or opportunities 248. For example, recommendations 246 and/or opportunities 248 may indicate a prediction of increased sales revenue for pursuing the recommendations or opportunities, respectively, and this prediction of increased sales revenue may be included in prediction of sales 250. Prediction of sales 250 may also include a prediction of sales without pursing any recommendations 246 and/or opportunities 248, such as by the business maintaining the status quo. AI agents 232 may generate prediction of sales 250.

Prediction of sales 250 may be based on economic statistics, such as economic statistics accessible by analytics engine 204 in environment 106.

It will be understood that business overview 234 may include fewer or more aspects than those discussed above, and may include other aspects in addition to or instead of those discussed above.

Business over 234 may also be presented in one or more documents, which may be shared with user device 102, such as within output 208. Business overview 234 may also be presented on a website accessible to user device 102, in an email or some other format accessible to a user associated with the business and/or user device 102.

FIG. 13 depicts business plan 236, according to some examples. In some examples, business plan 236 may summarize or include some or all of input 202 and/or some or all of business overview 234. In other examples, business plan 236 may be generated based on input 202 and/or business overview 234 using AI agents 232.

It will also be understood that business plan 236 may include some overlap with recommendations 246. However, business plan 236 may provide more detail than recommendations 246 for improving the business, as discussed in detail below. In particular, business plan 236 may indicate concrete steps for achieving some or all of recommendations 246, as well as potentially other recommendations. In other examples, business plan 236 may include steps which may be automated, in whole or in part, by AI agents 232 or another AI or software tool, e.g. which may be executed by an AI agent, and so business plan 236 may include enough detail for the AI agent to execute the steps.

Business plan 236 may include a strategic plan 260, which may indicate high level opportunities and recommendations which the business can pursue to increase profitability, growth and other desirable aspects of the business. For example, strategic plan 260 may include a long-term strategy or direction for the business to improve sales or profitability, such as increasing automation in the business, reducing overhead, expanding into foreign markets, etc. Strategic plan 260 may also summarize other plans within business plan 236, which are discussed in further detail below. Strategic plan 260 may be generated by AI agents 232.

Business plan 236 may also include a research and development plan 262, which may indicate industries or technologies the business should invest in for research and development. For example, research and development plan 262 may indicate that the business should focus on improving the technology of a certain product, improving the manufacturing process of that product or designing a new product altogether in an industry previously unexplored by the business. Other examples of research and development plan 262 may also be possible. Research and development plan 262 may also be based on strategic plan 260, which may indicate a certain product, industry or technology the business should focus on or invest more resources into. Research and development plan 262 may be generated by AI agents 232.

Business plan 236 may further include marketing plan 264, which may indicate marketing strategies the business should explore, different types of marketing for the business, recommendations for a specific marketing campaign, recommendations for outsourcing marketing to a specific vendor or bringing marketing in-house within the business, etc. For example, marketing plan 264 may generate and include a full marketing campaign, such as a social media campaign showcasing a product sold by the business with a certain aesthetic. Marketing plan 264 may also be based on strategic plan 260, which may indicate a certain product the business should focus on or invest more resources into, and so marketing plan 264 may provide recommendations and/or a concrete plan for marketing that product. Marketing plan 264 may be generated by AI agents 232.

In addition, business plan 236 may include operational plan 266, which may indicate improvements to one or more operational inefficiencies in the business. For example, operational inefficiencies may have been indicated in opportunities 248 in business overview 234. Operational plan 266 may include steps for improving the operations of the business, such as including AI and/or automation in the business. Operational plan 266 may also be based on strategic plan 260, which may indicate certain high-level initiatives or directions the business should pursue long term. Operational plan 266 may be generated by AI agents 232.

Business plan 236 may also include supply chain plan 268, which may indicate possible improvements to the supply chain of the business. Improvements may include changing or diversifying suppliers, modifying shipment frequency, out-sourcing certain manufacturing, moving some manufacturing in-house, modifying delivery or shipment of products, changes to logistics, etc. Supply chain plan 268 may also be based on strategic plan 260, which may indicate certain high-level initiatives or directions the business should pursue long term, such as expansion into a foreign market. For example, supply chain plan 268 may indicate recommendations and steps for building a supply chain to expand sales into a new or foreign market. In another example, supply chain plan 268 may indicate robotics equipment which may be incorporated into logistics tasks to increase profitability. In a further example, supply chain plan 268 may recommend an AI tool for processing incoming and outcoming packages, such as a tool capable of using image processing to read packaging labels and input this data into a logistics system. Supply chain plan 268 may be generated by AI agents 232.

Business plan 236 may further include financial plan 270, which may indicate steps for improving the finances of the business, financial management techniques, etc. For example, financial plan 270 may indicate software which may improve the finances of the business, such as AI or automation of certain bookkeeping, payroll, invoice processing, etc. Financial plan 270 may also be based on strategic plan 260, and so may indicate certain improvements or changes to the finances of the business after following strategic plan 260, including research and development plan 262, marketing plan 264, operational plan 266, supply chain plan 268 and/or other plans. Financial plan 270 may be generated by AI agents 232.

It will be understood that business plan 236 may include fewer or more plans than those discussed above, and may include other aspects in addition to or instead of those discussed above.

Business plan 236 may also be presented in one or more documents, which may be shared with user device 102, such as within output 208. Business plan 236 may also be presented on a website accessible to user device 102, in an email or some other format accessible to a user associated with the business and/or user device 102.

Furthermore, business plan 236 may include aspects which may be automated and performed by one or more software tools, such as an AI tool or AI agent, robotics equipment, etc. Business plan 236 may be stored in a format which may be easily executed by an AI tool or some other automation software.

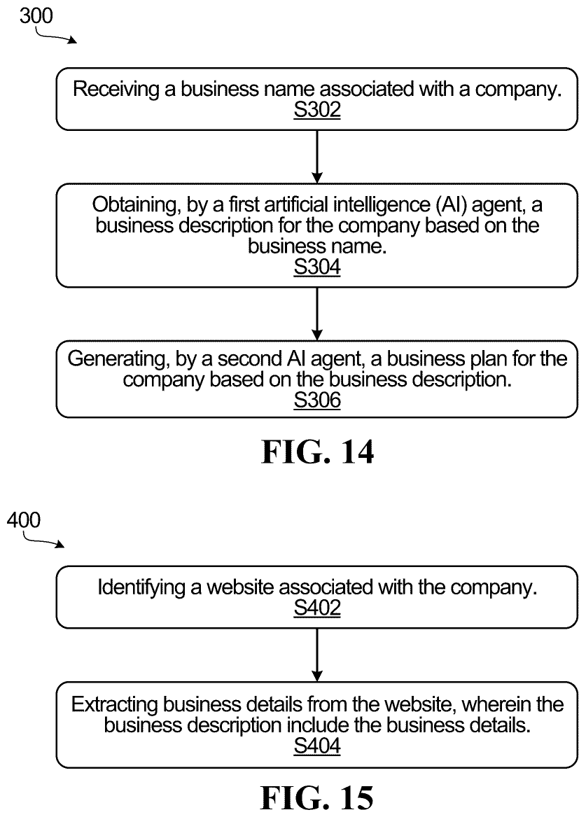

FIG. 14 depicts a method 300 for generating a business description and/or a business plan for a company, such as business description 240 and/or business plan 236. Method 300 may be performed by system 200, and in particular using analytics engine 204.

A step S302, a business name associated with the company is obtained.

For example, business name 212 may be received in input 202 from user device 102. Business name 212 may be received by analytics engine 204.

In other implementations, business name 212 may be received by a first AI agent, such as by first AI agent 232a.

In some other examples, additional or other information may also or instead be received by analytics engine 204, such as industry 214, company website 216, revenue 218, number of employees 220, supplier 222 and/or competitor 224. Analytics engine 204 may also or instead receive information pertaining to a customer of the business.

At step S304, a business description for the company is obtained based on the business name by a first AI agent.

For example, business description 240 may be obtained by first AI agent 232a. Business description 240 may be based on business name 212 received at step S302.

First AI agent 232a may generate business description 240 based on business name 212. For example, first AI agent 232a may query environment 106 based on business name 212 to retrieve information associated with the business. In some examples first AI agent 232a may query the Internet and/or an intranet to determine industry 214, obtain company website 216, estimate or obtain revenue 218 and estimate or obtain number of employees 220. First AI agent 232a may also query the Internet and/or an intranet for supplier 222, which may include one or more suppliers of the business, and competitor 224, which may include one or more competitors of the business. First AI agent 232a may also query the Internet and/or an intranet for one or more customers of the business. For example, first AI agent 232a may query company websites 144 (such as websites associated with the business itself, suppliers and/or competitors) and company internal systems 144 (including internal systems of the business, suppliers, vendors, customers, etc., which are accessible to analytics engine 104). First AI agent 232a may be equipped to scrape or extract information from websites identified during querying of environment 106.

First AI agent 232a may use information associated with the business that was obtained from environment 106 to generate business description 240, in addition to or instead of input 202. For example, first AI agent 232a may use information associated with the business that was obtained from environment 106 to generate business description 240, in addition to or instead of input 202. In some examples, first AI agent 232a may summarize its query results from the query of environment 106, while in other examples first AI agent 232a may obtain business description 240 from environment 106, such as from a news website or company website.

In other examples, first AI agent 232a may have received some or all of information associated with the business within input 202, and so AI agent 232a may summarize input 202 to generate business description 240. In other examples, AI agent 232a may still obtain some of the information associated with the business from environment 106.

Business description 240 may include at least one of business name 212, industry 214, company website 216, revenue 218, number of employees 220, supplier 222 and/or competitor 224. Business description 240 may additionally or instead include customers of the business.

In some implementations, business description 240 may also include a summary of at least one of internal analysis 242, external landscape 244, recommendations 246, opportunities 248 and/or prediction of sales 250. First AI agent 232a may also use information obtained from environment 106 to generate at least one of internal analysis 242, external landscape 244, recommendations 246, opportunities 248 and/or prediction of sales 250.

It will be understood that in some implementations, instead of just obtaining business description 240 at step S302, analytics engine 204 may obtain business overview 234. As noted above, business overview 234 may include at least one of business description 240, internal analysis 242, external landscape 244, recommendations 246, opportunities 248 and/or prediction of sales 250.

At step S306, a business plan for the company is generated by a second AGI agent based on the business description.

For example, second AI agent 232b may generate business plan 236 for the company based on the business description obtained at step S306, such as business description 240. Business plan 236 may include at least one of strategic plan 260, research and development plan 262, marketing plan 264, operational plan 266, supply chain plan 268 and/or financial plan 270.

In some examples, business plan 236 may include a recommendation for incorporating AI or analytics into the company, such as to replace inefficiencies within the company with AI-assisted automation. Business plan 236 may also include a prediction of cost saving from following the recommendation to incorporate AI or analytics into the company.

Second AI agent 232b may generate business plan 236 based on one or more aspects of the business summarized in business description 240, such as business name 212, industry 214, company website 216, revenue 218, number of employees 220, supplier 222, competitor 224 and/or customers of the business. In some other implementations, business description 240 may also include a summary of internal analysis 242, external landscape 244, recommendations 246, opportunities 248 and/or prediction of sales 250. Second AI agent 232b may also generate business plan 236 based on input 202. In addition, second AI agent 232b may also query environment 106 to obtain information or further details about the business, other industries, markets, technologies, company websites 144, company internal systems 144, etc. Second AI agent 232b may generate business plan 236 based on the query results from environment 106.

In further implementations where business overview 234 is obtained at step S302, second AI agent 232b may generate business plan 236 based on business overview 234.

Method 300 may be performed iteratively. For example, feedback or human input may be received via input 202 to analytics engine 204, such as from user device 102. The feedback or human input may be used to modify the business description at step S304. Step S306 may be repeated to generate a modified business plan based on the modified business description. Human input may specify changes, corrections, tweaks, augmentations or other changes to business description, which may be useful for analytics engine 204 to determine an effective business plan at step S306. Feedback may also include a performance outcome of the business plan, customer feedback, sensor data, computer alerts, a competitor market shift, etc. Feedback or human input may be received again even after the modified business plan is generated or executed to iteratively refine the business plan.

In some implementations, industry benchmarks may also be used to determine when iterations of method 300 should cease. Industry benchmarks may be obtained from environment 106.

Method 300 may include an additional step of executing the business plan, such as business plan 236. Business plan 236 may be executed by an AI agent, as will be discussed in further detail below. The discussion below with respect to executing business plan 236 may equally apply to method 300.

It will be appreciated that in addition to using second AI agent 232b to generate business plan 236, business plan 236 may also be generated using other aspects/modules within analytics engine 204, such as those depicted in FIG. 3 and FIGS. 4A-4B with respect to analytics engine 104 and analytics engine 104′, respectively.

Moreover, any of the steps of method 300 may be performed using other aspects/modules within analytics engine 204, such as those depicted in FIG. 3 and FIGS. 4A-4B with respect to analytics engine 104 and analytics engine 104′, respectively. As noted above, in some implementations, analytics engine 204 may be generally similar or identical to analytics engine 104 and/or analytics engine 104′.

Steps of method 300 which are performed by an AI agent may be performed by one or more AI agents. As well, steps of method 300 which are performed by the same AI agent may be performed by different AI agents or a different combination of AI agents in other implementations. Similarly, steps of method 300 which are performed by different AI agents may be performed by the same AI agent or a group of AI agents including a common AI agent in other implementations. It may also be appreciated that an AI agent may be used to denote a group of AI agents or a common AI agent in a group of AI agents.

Method 300 may perform additional or fewer steps in addition to those discussed above. For example, method 300 may include additional steps of including business description 240 and/or business plan 236 in output 206, which may be provided to user device 102. Method 300 may include the steps of outputting output 206 to user device 102.

Method 300 may additionally omit step S306 and only perform step S302 and step S304. Other steps may also be performed after step S304, such as outputting business description 240 to user device 102.

In some implementations, some steps of method 300 may also include additional steps not already discussed. For example, FIG. 15 depicts a method 400 for performing step S304 in method 300 to obtain business description 240, and in particular to obtain a summary of a website associated with the company or business, according to some implementations. Method 400 may be performed by analytics engine 204.

At step 402, a website associated with the company is identified.

For example, the website may be company website 216. The website may be hosted by the business, an affiliate of the business, a news site, a compliance or government agency or some other entity which has described the business on its website. The website may also be identified by searching environment 106, including company websites 142, company internal systems 144, third party systems 146, etc. It will be understood that although details of the business may be obtained from its own website, details of the business may also be found on websites not directly managed or hosted by the business.

Business details may include a description of the business (which may be used to generate business description 240), business name 212, industry 214, company website 216, revenue 218, number of employees 220, supplier 222, competitor 224 and/or customers of the business.

First agent 232a may determine that the website is associated with the company or business based on business name 212, which was received by analytics engine 204 at step 302. Business name 212 may correspond to the business name listed on the website, in the website Uniform Resource Locator (URL), a subject of a news article on the website, etc.

Other methods for determining that the website is associated with the business may also be possible. For example, first agent 232a may be configured to predict whether a website is associated with a certain business after reviewing the website (and potentially after scraping some data from the website).

At step S404, business details from the website are extracted, wherein the business description includes the business details.

For example, first agent 232a may extract or scrape business details from the website, such as company website 216 or some other website describing the business (e.g. any of company websites 142 in environment 106). First agent 232a may extract or scrape business industry 214, company website 216, revenue 218, number of employees 220, supplier 222, competitor 224 and/or customers of the business.

Step S404 may be repeated and/or combined with step S402. As noted above, business details may be scraped from the website before identifying the website as associated with the company in step S402.

Fewer or additional steps (not shown) may also be performed in method 400.

Steps of method 400 which are performed by an AI agent may be performed by one or more AI agents. As well, steps of method 400 which are performed by the same AI agent may be performed by different AI agents or a different combination of AI agents in other implementations. Similarly, steps of method 400 which are performed by different AI agents may be performed by the same AI agent or a group of AI agents including a common AI agent in other implementations. It may also be appreciated that an AI agent may be used to denote a group of AI agents or a common AI agent in a group of AI agents.

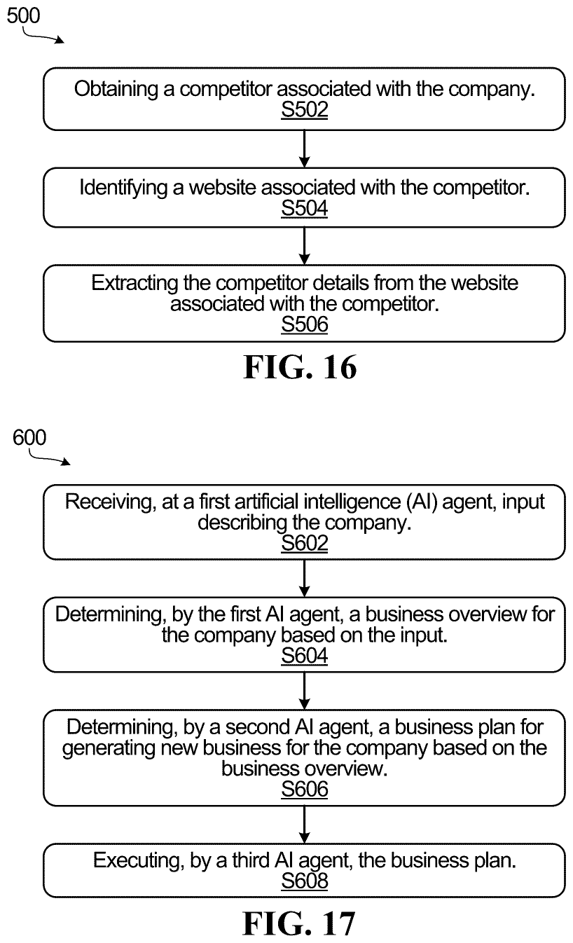

FIG. 16 depicts a method 500 for performing step S304 in method 300 to obtain business description 240, and in particular to obtain a summary of a website associated with a competitor, according to some implementations. Method 500 may be performed by analytics engine 204.

At step S502, a competitor associated with the company may be obtained.

For example, competitor 224 may be obtained from input 202.

In other examples, competitor 224 may be obtained from a website, such as company websites 142, a news website, or some other website associated with the business (e.g. company websites 142). First agent 232a may review one or more websites and determine the name of a competitor of the business (e.g. competitor 224).

In further examples, competitor 224 may be identified using other resources in environment 106, such as company internal systems 144, third party systems 146, social media 150, etc.

At step S504, a website associated with the competitor is identified.

For example, first agent 232a may search for websites associated with competitor 224 on the Internet and/or throughout environment 106. In other examples, first agent 232a may have also determined the website associated with competitor 224 when first agent 232a identified competitor 224, such as by locating the competitor website or some other resource linking to the competitor website.

At step S506, the competitor details from the website associated with the competitor are extracted.

For example, details describing competitor 224 may be extracted or scraped from the competitor website using first agent 232a.

Fewer or additional steps (not shown) may also be performed in method 500.

Steps of method 500 which are performed by an AI agent may be performed by one or more AI agents. As well, steps of method 500 which are performed by the same AI agent may be performed by different AI agents or a different combination of AI agents in other implementations. Similarly, steps of method 500 which are performed by different AI agents may be performed by the same AI agent or a group of AI agents including a common AI agent in other implementations. It may also be appreciated that an AI agent may be used to denote a group of AI agents or a common AI agent in a group of AI agents.

In other implementations, method 500 may be used to obtain a summary of a website associated with at least one of a competitor, a supplier or a customer. For example, at step S502, at least one of a competitor, a supplier or a customer associated with the company may be obtained. At step S504, a website associated with at least one of the competitor, the supplier or the customer may be identified. At step S506, details may be extracted from the website of the at least one of the competitor, the supplier or the customer. Other implementations of method 500 may also be possible.

FIG. 17 depicts a method 600 for executing a business plan for a company, according to some examples. It will be appreciated that method 600 may include steps overlapping with method 300, method 400 and/or method 500 discussed above. Method 600 may be performed by analytics engine 204.

At step S602, input describing the company is received at a first AI agent.

For example, input 202 may be received at first AI agent 232a. Input 202 may include at least one of business name 212, industry 214, company website 216, revenue 218, number of employees 220, supplier 222, competitor 224 and/or customers of the business.

First AI agent 232a may include an LLM or MLLM. First agent 232a may also include one or more models or tools to assist first AI agent 232a with completing one or more tasks, such as receiving input and determining business overview 234.

At step S604, a business overview for the company is determined by the first AI agent based on the input.

For example, business overview 234 may be determined by first AI agent 232a based on the input received at step S602, such as input 202. Business overview 234 may include at least one of business description 240, internal analysis 242, external landscape 244, recommendations 246, opportunities 248 and/or prediction of sales 250.

Business description 240 may be generated as already discussed above with respect to step S304 in method 300. As well, description 240, internal analysis 242, external landscape 244, recommendations 246, opportunities 248 and/or prediction of sales 250 may also be determined using input 202 and environment 106. Input 202 may be used to query environment 106, such as company websites 142, company internal systems 144, third party systems 146, sensors 148, social media 150, etc. First AI agent 232a may retrieve some or all of business description 240 from the query results from environment 106 and/or first agent 232a may generate some or all of business description 240 based on the query results from environment 106.

For example, prediction of sales 250 may be based on economic statistics. First AI agent 232a may retrieve economic statistics from environment 106 or determine economic statistics from other data retrieved from environment 106. Prediction of sales 250 may also be based on other data describing the business, such as other aspects of business over 234 and/or input 202, as well as other information in environment 106.

At step S606, a business plan for the company is determined by a second AI agent based on the business overview.

For example, business plan 236 may be determined by second AI agent 232b based on the business overview determined at step S604, such as business overview 234.

In some implementations, second AI agent 232b may determine business plan 236 based on business overview 234 and input 202. Second AI agent 232b may also query environment 106 to generate business plan 236. For example, second AI agent 232b may generate the query based on business overview 234 and/or input 202. Second AI agent 232b may receive details from environment 106 based on the query, which may include economic statistics, details from company websites 142, company internal systems 144, third party systems 146, sensors 148, social media 150 and communication systems 152. Business plan 236 may be generated based on the availability of various systems within environment 106. In the example where business plan 236 include marketing plan 264, marketing plan 264 may be generated based on the resources available in social media 150.

In alternate implementations, second AI agent 232b may generate business overview 234 only using input 202.

Business plan 236 may include at least one of strategic plan 260, research and development plan 262, marketing plan 264, operational plan 266, supply chain plan 268 and/or financial plan 270.

In some implementations, business plan 236 may be generated as already discussed above with respect to step S306 in method 300.

Second AI agent 232b may include an LLM. Second agent 232b may also include one or more models or tools to assist second AI agent 232b with completing one or more tasks, such as determining business plan 236.

At step S608, the business plan is executed by a third AI agent.

For example, third AI agent 232c may execute business plan 236.

In examples where business plan 236 includes strategic plan 260, third AI agent 232c may initiate strategic changes by communicating with employees of the business over company internal systems 144 and/or communication systems 152 about new research directions specified by research and development plan 262. Third AI agent 232c may generate, either autonomously or with human aid, strategy documents for business executives and management after reviewing documents within the business. Third AI agent 232c may also coordinate, either autonomously or with human aid, the execution of other plans within business plan 236.

In examples where business plan 236 includes research and development plan 262, third AI agent 232c may initiate research and development by communicating with employees of the business over company internal systems 144 and/or communication systems 152 about new research directions specified by research and development plan 262. In some implementations, third AI agent 232c may partial and autonomously complete research and development, such as by simulating various solutions to an existing problem indicated by research and development plan 262. Third AI agent 232c may also access real testing data using sensors 148, which may allow it to autonomously, or with human aid, test solutions to existing problems indicated by research and development plan 262. In other implementations, third AI agent 232c may contact suppliers or external facilities over third party systems 146 and/or communication systems 152 about research and development initiatives. In further examples, third AI agent 232c may contract a supplier based on business plan 236, such as to obtain more materials required for research and development initiatives.

In examples where business plan 236 includes marketing plan 264, third AI agent 232c may implement a marketing campaign specified by marketing plan 264 in environment 106, and in particular in social media 106. Other marketing platforms in environment 106 may also be available, such as communications systems 152 (e.g. email campaigns). Third AI agent 232c may implement marketing campaigns autonomously or with human aid.

In examples where business plan 236 includes operational plan 266, third AI agent 232c may contact employees of the business over company internal systems 144 and/or communication systems 152 about new operational initiatives specified in operational plan 266. Third AI agent 232c may also autonomously, or with human aid, implement new operational initiatives, such as by developing or co-developing new applications (e.g. software applications) specified by operational plan 266.

In examples where business plan 236 includes supply chain plan 268, third AI agent 232c may contact employees of the business over company internal systems 144 and/or communication systems 152 about new supply chain initiatives specified in supply chain plan 268. Third AI agent 232c may also autonomously, or with human aid, implement new supply chain initiatives, such as by developing or co-developing new applications (e.g. software applications) specified by supply plan 266, contacting suppliers over third party systems 146 and/or communications systems, researching new suppliers and/or foreign markets using environment 106, etc. In further examples, third AI agent 232c may contract a supplier based on business plan 236, such as to increase supply, obtain new products, or in fulfilment of some other business objective.

In examples where business plan 236 includes financial plan 270, third AI agent 232c may contact employees of the business over company internal systems 144 and/or communication systems 152 about new financial initiatives specified in financial plan 270. Third AI agent 232c may also autonomously, or with human aid, implement new operational initiatives, such as by developing or co-developing new applications (e.g. software applications) specified by financial plan 270, correspond with financial institutions, suppliers and other third parties using third party systems 146 and/or communication systems 152, review financial documents using company internal systems 144, etc.

Method 600 may be performed iteratively. For example, feedback or human input may be received via input 202 to analytics engine 204, such as from user device 102. The feedback or human input may be used to modify the input at step S602, and a modified business overview and business plan may be generated at steps S604 and S606. The modified business plan may be executed at step S608. Alternatively or in addition, the feedback or human input may be used to modify the business overview at step S604, and a modified business plan may be generated and executed at steps S606 and S608. Alternatively or in addition, the feedback or human input may be used to modify the business plan at step S606, and the modified business plan may be executed at step S608. Human input may specify changes, corrections, tweaks, augmentations or other changes to business description, which may be useful for analytics engine 204 to determine and execute an effective business plan at steps S606 and S608. Feedback may also include a performance outcome of the business plan, customer feedback, sensor data, computer alerts, a competitor market shift, etc. Feedback or human input may be received again even after the modified business plan is generated or executed to iteratively refine the business plan.

In some implementations, industry benchmarks may also be used to determine when iterations of method 600 should cease. Industry benchmarks may be obtained from environment 106.

Any of the steps of method 600 may be performed using other aspects/modules within analytics engine 204, such as those depicted in FIG. 3 and FIGS. 4A-4B with respect to analytics engine 104 and analytics engine 104′, respectively. As noted above, in some implementations, analytics engine 204 may be generally similar or identical to analytics engine 104 and/or analytics engine 104′.

Steps of method 600 which are performed by an AI agent may be performed by one or more AI agents. As well, steps of method 600 which are performed by the same AI agent may be performed by different AI agents or a different combination of AI agents in other implementations. Similarly, steps of method 600 which are performed by different AI agents may be performed by the same AI agent or a group of AI agents including a common AI agent in other implementations. It may also be appreciated that an AI agent may be used to denote a group of AI agents or a common AI agent in a group of AI agents.

Method 600 may perform additional or fewer steps in addition to those discussed above. For example, method 600 may include additional steps of including business description 240 and/or business plan 236 in output 206, which may be provided to user device 102. Method 600 may include the steps of outputting output 206 to user device 102.

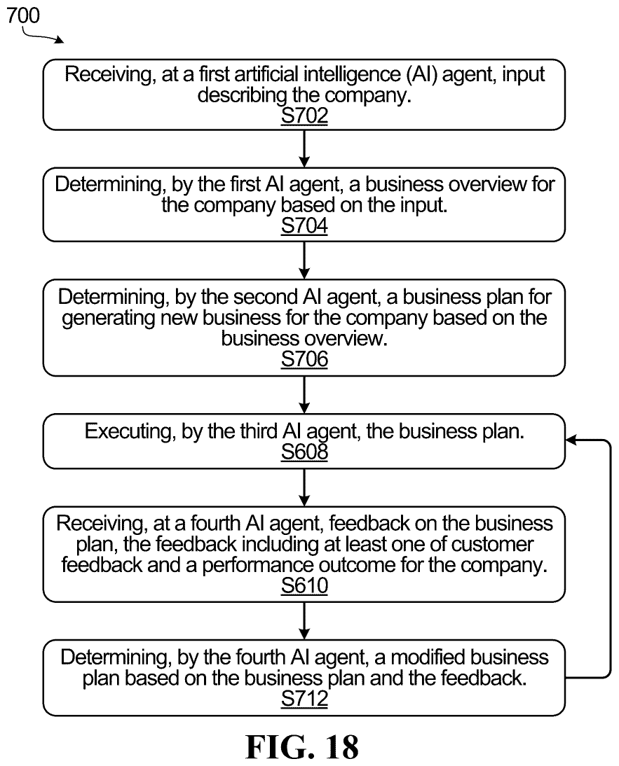

FIG. 18 depicts another method 700 for executing a business plan for a company, according to further examples. It will be appreciated that method 700 may include steps overlapping with method 300, method 400, method 500 and/or method 600 discussed above. Method 600 may be performed by analytics engine 204.

Moreover, method 700 may be substantially identical to method 600. For example, method steps S702, S704, S706 and S708 in method 700 are identical or substantially identical to method steps S602, S604, S606 and S608 in method 600.

At method step S710, feedback on the business plan is received at a fourth AI agent, the feedback including at least one of customer feedback and a performance outcome for the company.

For example, feedback on business plan 236 may be received at fourth AI agent 232d. In this step, the term received may also mean generated, obtained, retrieved, estimated, evaluated or derived.

Feedback may be provided by a user of user device 102, such as by providing addition input to analytics engine 204. Feedback may also be received from another user device or an external sever.

As noted above, feedback may include customer feedback and/or a performance outcome for the company. In the example where feedback includes customer feedback, the customer may be a user of user device 102 and may provide feedback using user device 102, such as by providing feedback within input 202 to analytics engine 204.

Customer feedback may also be obtained from environment 106, such as from company websites 142 (e.g. comments or reviews), company internal systems 144 (e.g. feedback from a customer which has been recorded by the company in a database), third party systems 146 (e.g. feedback from customer systems), sensors 148 (e.g. microphones and/or cameras installed at a customer location), social media 150 (e.g. social media postings or comments), and/or communication systems 152 (e.g. emails).

In the example where feedback includes a performance outcome for the company, the performance outcome may be obtained, evaluated and/or determined by analytics engine 204 and/or fourth AI agent 232d. Fourth AI agent 232d may retrieve performance outcome or information necessary to determine performance outcome from environment 106, such as from company internal systems 144 (e.g. a company performance report generated by company executives, employees or third parties), company websites 142, sensors 148 (e.g. measuring the performance of research and development initiatives or supply chain metrics), etc. For example, sensors 148 may record shipping quantities, which may be used to determine the performance outcome of a supply chain plan 268 executed at step S708. Social media engagement may also be measured from social media 150 to evaluate the performance outcome of a marketing plan 264. It will be appreciated that other examples are also possible.

Fourth AI agent 232d may be configured to obtain information about performance outcomes from environment 106 and evaluate or determine performance outcomes based on the information it retrieved.

It will be appreciated that in some implementations, feedback may be provided before any one of S702, S704, S706 and S708, such as in the case that output 208 is provided to user device 102 or some other device at the beginning or end of each of the steps of method 700.

At step S712, a modified business plan may be determined by the fourth AI agent based on the business plan and the feedback.

For example, business plan 236 may be modified by fourth AI agent 232d based on the feedback received at step S712.

As noted above, feedback may include customer feedback and/or a performance outcome for the company. In the example where feedback includes customer feedback, customer feedback may specify that some aspect of business plan 236 should be modified or deleted. For example, one or more of strategic plan 260, research and development plan 262, marketing plan 264, operational plan 266, supply chain plan 268, financial plane 270 or some other aspect of business plan 236 may be modified or deleted.

The customer feedback may directly indicate that an aspect of business plan 236 should be modified. For example, the customer feedback may specify that a marketing campaign associated with marketing plan 264 should be removed.

In other implementations, the customer feedback may be interpreted by fourth AI agent 232d to determine an appropriate modification to business plan 236. For example, the customer feedback may indicate that a marketing campaign associated with marketing plan 264 is confusing, and so marketing plan 264 may be modified to make the marketing campaign less confusing. Alternatively, the customer feedback may indicate that a marketing campaign associated with marketing plan 264 is successful (e.g. positive customer feedback on the campaign), and so marketing plan 264 may be modified to expand the marketing campaign to more social media platforms and/or other websites or mediums.

In the example where feedback includes a performance outcome for the company, the performance outcome may specify that some aspect of business plan 236 should be modified or deleted. The performance outcome may be interpreted by fourth AI agent 232d to determine an appropriate modification to business plan 236. For example, the performance outcome may indicate that a marketing campaign associated with marketing plan 264 is unsuccessful (e.g. low sales), and so marketing plan 264 may be modified to make the marketing campaign more attractive. Fourth AI agent 232d may create a new marketing plan 264 or modify marketing plan based on queries of environment 106 for possible explanation for the poor performance outcome. As well, customer feedback may also assist fourth AI agent 232d in creating a new marketing plan 264. Alternatively, the performance outcome may indicate that a marketing campaign associated with marketing plan 264 is successful (e.g. increased sales since introducing the marketing campaign), and so marketing plan 264 may be modified to expand the marketing campaign to more social media platforms and/or other websites or mediums.

Other modifications to business plan 236 may also be possible. For example, supply chain plan 268 may result in poor logistics performance outcomes (e.g. lost deliveries, delays in the supply chain) or customer feedback about late deliveries. Supply chain plan 268 may be modified based on this feedback.

It will be appreciated that other examples of modification to business plan 236 based on feedback may also be possible.

Steps S708, S710 and S712 may be repeated iteratively. Modified business plan 236 may be executed at step S708, such as by third AI agent 232c. At step S710, feedback may be received again after executing modified business plan 236 at step S708. At step S712, business plan 236 may be modified again after this new feedback is received. The twice modified business plan 236 may then be executed again at step S708, and so on. It will be understood that in this way, business plan 236 may continuously adapt to customer feedback and performance outcomes, which may be affected both by business plan 236 itself and changing conditions in environment 106, the market, the economy, the regulatory landscape and other factors.

As well, feedback may include other forms of feedback beyond customer feedback and performance outcomes. Feedback may be received from the business itself, from suppliers, competitors, government organizations and any other organizations interacting with the business. Feedback may be obtained, received or derived from environment 106, such as a news site or government organization, as well as over email, social media, and other mediums.

Feedback and/or input into analytics engine 204 (such as input 202) may also include data collected by sensors 148. For example, in a shipping facility or other site associated with the business, a fifth AI agent may receive a label image associated with merchandise sent or received by the company. The label may include merchandise details. For example, fifth AI agent 232e may receive a label image associated with merchandise sent or received by the company. The label may be detected by sensors 148, obtained from company internal systems 144 and/or third party systems 146. The merchandise details may be determined by fifth AI agent 232e, such as using machine vision or another technique capable of extracting merchandise details from the label. As noted above, the merchandise details may be included in input 202 as step S702 (or step S602 in method 600) and/or included in feedback at step S710.

In some implementations, industry benchmarks may also be used to determine when iterations of method 700 should cease. Industry benchmarks may be obtained from environment 106.

Any of the steps of method 700 may be performed using other aspects/modules within analytics engine 204, such as those depicted in FIG. 3 and FIGS. 4A-4B with respect to analytics engine 104 and analytics engine 104′, respectively. As noted above, in some implementations, analytics engine 204 may be generally similar or identical to analytics engine 104 and/or analytics engine 104′.

Steps of method 700 which are performed by an AI agent may be performed by one or more AI agents. As well, steps of method 700 which are performed by the same AI agent may be performed by different AI agents or a different combination of AI agents in other implementations. Similarly, steps of method 700 which are performed by different AI agents may be performed by the same AI agent or a group of AI agents including a common AI agent in other implementations. It may also be appreciated that an AI agent may be used to denote a group of AI agents or a common AI agent in a group of AI agents.

Method 700 may perform additional or fewer steps in addition to those discussed above. For example, method 700 may include additional steps of including business description 240 and/or business plan 236 in output 206, which may be provided to user device 102. Method 700 may include the steps of outputting output 206 to user device 102.

### Sensing Applications

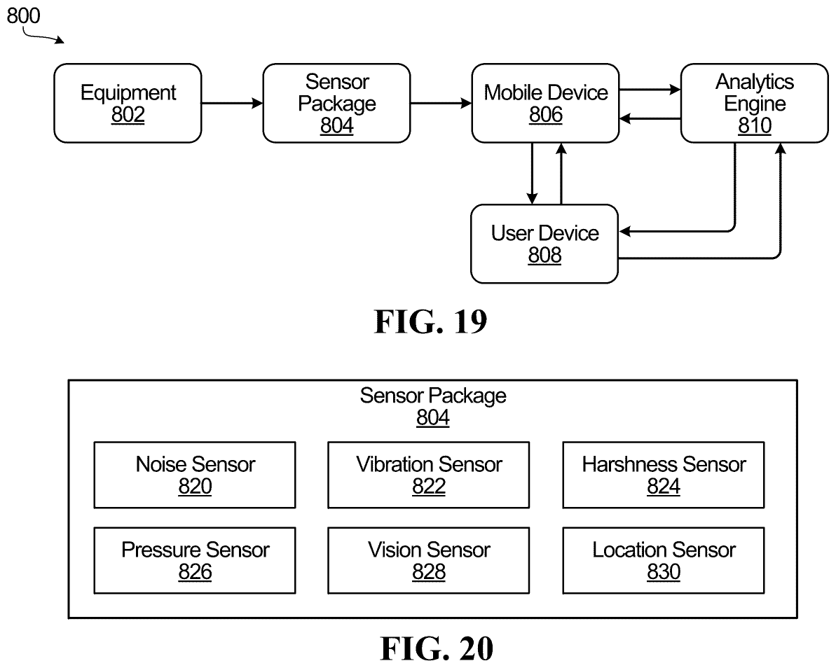

FIG. 19 depicts a system 800 for monitoring the performance of equipment. System 800 may be used by a business or company, an individual, a household, a building manager, a systems manager and/or any other entity interested in monitoring equipment or a physical environment.

System 800 includes equipment 802, sensor package 804, mobile device 806, user device 808 and analytics engine 810.

Equipment 802 may include machinery, such as a furnace, an assembly line, a vehicle, computer servers, etc. Equipment 802 may be located in a heating, ventilation and air conditioning (HVAC) unit, a manufacturing plant, a cement plant, a transportation vehicle, a retail environment, a telecommunications facility, a mine, agriculture equipment, a residential facility and/or a warehouse. As used herein, equipment 802 may also include a physical environment, such as a room within a warehouse, a shipping container, a basement, a pipe, etc. Equipment 802 may generally include any machine or physical environment which produces a physical interaction with its surroundings, such as by producing heat, sound, movement, light, electromagnetic radiation, etc. Other physical interactions between equipment 802 and its surroundings may also be possible.

Sensor package 804 may include one or more sensors configured to locate, measure or monitor equipment 802, such as machinery or a physical environment. For example, sensor package 804 may measure the location, heat, sound movement, light and/or electromagnetic radiation produces by a machine or physical environment. Other physical interactions may also be possible.

FIG. 20 depicts sensor package 804 according to some examples. Optionally, sensor package 804 may include a noise sensor 820, a vibration sensor 822, a harshness sensor 824 (e.g. for measuring temperature), a pressure sensor 826, a vibration sensor 828 and/or a location sensor 830 (e.g. a GPS). For example, noise sensor 820 may measure noise data in the inaudible range for humans. Noise sensor 820 may be a microphone.

Other sensors may also be possible in sensor package 804. Although not exhaustive and optional only, sensor package 804 may include at least one of a noise sensor, a vibration sensor, a temperature sensor, a relative humidity sensor, a gyroscope, a magnetometer, a global positional system (GPS) device, a microphone, a vision, a light sensor, a vibration sensor, a harshness sensor, a pressure sensor, a current sensor, a carbon dioxide sensor, a water leakage sensor, a passive infrared (PIR) sensor, a magnetic door sensor, a soil sensor, an air quality sensor, a volatile organic compounds sensor or a particulate matter sensor.

Sensor package 804 may include one or more of these sensors, and sensor package 804 may include duplicates of each sensor and/or other sensors not discussed above.

Sensor package 804 may be installed or located in proximity to equipment 802. Sensor package 804 may be installed or located such that it may monitor equipment 802. In some examples, sensor package 804 or part of sensor package 804 may be installed within equipment 802 and/or integrated with equipment 802. For example, one of the sensors in sensor package 804 may be a sensor built into equipment 802, such as a temperature sensor.

Since sensor package 804 may include more than one sensor, different sensors in sensor package 804 may be located or installed at different locations. Sensors in sensor package 804 may be configured to communicate with one or more computing devices, as will be discussed in further detail below. The sensors may or may not be configured to communicate with one another.

It will be understood that environment 106 may include equipment 802 and sensor package 804. For example, sensors 148 in environment 106 may include sensor package 804. Third party systems 146, company internal systems 144 and/or communication systems 152 may also include equipment 802. Sensors 148 may also include equipment 802, such as if equipment 802 includes integrated sensors.

System 800 also includes a mobile device 806, which may communicate with sensor package 804. Sensors in sensor package 804 may be configured to transmit or communicate measurements of equipment 802 to mobile device 806. Sensor package 804 may communicate with mobile device 806 including one or more communication protocols, including Bluetooth™, WiFi, iBeacon, and/or other communication protocols. Multiple communication protocols may be used by sensor package 804, such as if different sensors in sensor package 804 transmit sensed data using different communication protocols.

In other implementations, sensor package 804 may directly connect to mobile device 806, such that some or each of sensors in sensor package 804 are directly connected to mobile device 806. This may be appropriate in examples where one or more sensors do not include networking capabilities, i.e. no capabilities for wireless transmission of data.

Mobile device 806 may be a computing device, such as a smartphone, cellphone, and/or any other device including a transceiver. For example, mobile device 806 may be a puck capable of receiving sensed data from sensor package 804 and transmitting that received sensed data to analytics engine 810, as will be discussed in further detail below. Mobile device 806 may transmit sensed data to analytics engine 810 either wirelessly or wired, such as using one or more communication protocols, including ethernet, Bluetooth™, WiFi, iBeacon, cellular and/or other communication protocols.

In some implementations, mobile device 806 may also include a processor and memory, and mobile device 806 may be configured to perform processing and/or pre-processing of sensed data received from sensor package 804 and collected from equipment 802. As will be discussed below, in further implementations, mobile device 806 may be configured to execute some or all of the processing of analytics engine 810.

Some sensors or all of sensors within sensor package 804 may be installed on mobile device 806. For example, if sensor package 804 includes noise sensor 820, noise sensor 820 may be a microphone. Noise sensor 820 may be integrated within mobile device 806, such as the default microphone in mobile device 806. In this example, mobile device 806 may be a smartphone and sensor package 804 may include the microphone in the smartphone as noise sensor 820. Furthermore, in this example, the microphone/noise sensor 820 and thus mobile device 806 may be placed in proximity to equipment 802, such that the microphone in sensor package 804 and mobile device 806 may monitor equipment 802.

It will be understood that environment 106 may also include mobile device 806. For example, any one of company internal systems 144, third party systems 146, sensors 148 (e.g. when the microphone of mobile device 806 is used to collect sensed data) and/or communication systems 152 may include mobile device 806. For example, communication systems 152 may include mobile device 806, which is used to collect or receive sensed data from sensor package 804 (e.g. sensors 148) and transmit the sensed data to analytics engine 810.

In some implementations, mobile device 806 may also communicate with user device 808. Mobile device 808 may transmit raw sensed data collected from sensor package 806 to user device 808 and/or user device 808 may send instructions to or configure mobile device 806.

It will be appreciated that user device 808 may be the same as or substantially similar to user device 102 discussed above in FIG. 1.

In some further implementations, user device 808 may include or be mobile device 806, such that a user may use their user device 808 to connect with sensor package 804 when they are in proximity of the communication network(s) or protocol(s) used by sensor package 804. In these implementations, however, mobile device 806 may only collect sensed data in real time from sensor package 804 when mobile device 806 is in proximity of sensor package 804 or the communication protocol of sensor package 804, which may be appropriate in specific use cases. In other use cases, sensed data may be continuously collected by sensor package 804, such as by noise sensor 820.

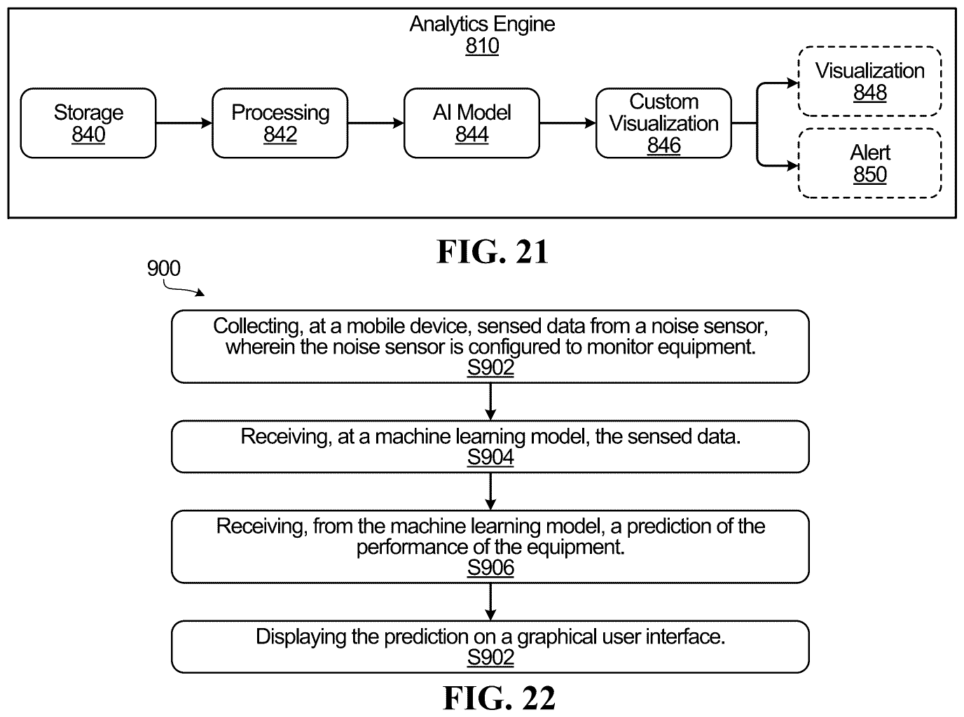

As noted above, mobile device 806 may transmit collected sensed data from sensor package 804 to analytics engine 810. Analytics engine 810 may be the same or substantially similar to analytics engine 104, analytics engine 104′ and/or analytics engine 204. For example, FIG. 21 depicts analytics engine 810, according to some implementations. Analytics engine 810 includes storage 840, processing 842, AI Model 844 and custom visualization 846. Analytics engine 810 may also include visualization 848 and/or alert 850. It will be understood that analytics engine 810 may include fewer or more modules or components than analytics engine 104, analytics engine 104′ and/or analytics engine 204. Analytics engine 810 may also or instead include other modules or components in addition to or instead of existing modules or components in analytics engine 104, analytics engine 104′ and/or analytics engine 204.

Analytics engine 810 may be hosted on a server and communicate with mobile device 806 and/or user device 808 over the Internet or some local network, such as an intranet, Bluetooth, iBeacon, etc. This may be an example of Cloud computing. In other implementations, analytics engine 810 may be hosted on mobile device 806 or user device 808. For example, mobile device 806 may transmit sensed data from sensor package 804 to user device 808, which may host a local copy of analytics engine 810. This may be an example of Edge computing. Alternatively, user device 808 may host some modules of analytics engine 810 and may transmit processed sensed data or calculations to a server hosting the other modules of analytics engine 810. This may be an example of Cloud and Edge computing. It will be appreciated that other examples may be possible.

As will be discussed below, analytics engine 810 may also communicate with user device 808. Analytics engine 810 may provide output to user device 808, such as a prediction of performance of equipment 802 determined by analytics engine 810. The output from analytics engine 810 may be displayed on a graphical user interface (GUI), which may be viewed on user device 808. User device 808 may also request information from analytics engine 810, such as sensed data or predictions from specific time periods. User device 808 may also configure analytics engine 810 to perform a certain type of calculation, analysis and/or generate a certain type of output.

Analytics engine 810 includes storage 840. Storage 840 may include one or more memories, which may be configured to store sensed data received from mobile device 806 and/or sensor package 804. As used herein, sensed data may include measurement data collected by sensor package 804 of equipment 802.

Processing 842 may perform pre-processing on the sensed data collected by sensor package 804. Processing 842 may include filtering, transforming, smoothing, cleaning, sanitizing padding and/or other operations for preparing sensed data for further analysis by analytics engine 810. In some implementations, processing 842 may be optional and may depend on the quality of sensed data collected by sensor package 804 of equipment 802.

In some examples, processing 842 may also include separating sensed data collected by different sensors in sensor package 804 and/or identifying erroneous or unreliable sensed data, which may not be appropriate for further analysis by analytics engine 810.

AI model 844 may include one or more AI models. As used herein, the term AI model may include neural networks, classifiers, machine learning models, regression models, and any other predictive models, including but not limited to other machine learning algorithms.

AI model 844 may have been pre-trained before sensed data was collected by sensor package 804 from equipment 802. In other examples, AI model 844 may have been trained or fine tuned based on historical sensed data collected by sensor package 804 from equipment 802.

AI model 844 may be trained, re-trained or fine tuned iteratively over time based on sensed data, predictions of performance of equipment 802, and/or new sensed data collected after the prediction of performance of equipment 802 is generated by AI model 844 (which may correspond to the actual performance of equipment 802) to improve the predictive capabilities of AI model 844. For example, predicted performance and corresponding actual performance of equipment 802 may be used to re-train or fine tune AI model 844. Some examples may include determining an error between actual performance and predicted performance of equipment 802 and re-training or fine-tuning AI model 844 based on this error. It will be appreciated that the longer AI model 844 is used to monitor equipment 802, the better AI model 844 may be at predicting performance of equipment 844.

Other training data may also be possible, such as training data related to different equipment and/or environment, such as training data obtained from environment 106. Training data may also be pre-processed by processing 842 before AI model 844 is trained, re-trained or fine-tuned on that training data.

AI model 844 may be configured to receive sensed data collected by sensor package 804 from equipment 802 and to generate a prediction of performance based on that sensed data. For example, AI model 844 may generate one or more of a prediction of failure of equipment 802, a prediction of mean time between failures (MTBF) of equipment 802, a prediction of required maintenance of equipment 802, a prediction for automatically adjusting operational parameters of equipment 802, and/or a prediction of the health of equipment 802. AI model 844 may also predict a time when maintenance of equipment 802 is likely to be required, a likely cause for the predicted failure of equipment 802, a life expectancy of equipment 802 before replacement may be necessary, etc.

AI model 844 may generate a prediction of performance based on sensed data which is continuously collected by sensor package 804, such as noise sensor 820, vibration sensor 822, harshness sensor 824, pressure sensor 826, vision sensor 828, location sensor 830, and/or another or different sensor. In other implementations, AI model 844 may generate a prediction of performance based on sensed data which is historical, collected in batches and/or uploaded to analytics engine 810 from a different period of time.

As noted above, AI model 844 may include more than one AI model. In these implementations, multiple AI models may be used to generate one or more predictions of performance, which may be integrated into a single result or may be viewed as separate metrics.

Custom visualization 846 may receive the prediction of performance from AI model 844 and generate a custom visualization of the prediction of performance, which may include one or more metrics related to the prediction of performance of equipment 802. Custom visualization 846 may be configured by user device 808, and may include a graph, a chart, a spreadsheet, a graphic, a pie chart and/or a report. For example, custom visualization 846 may include an LLM configured to interpret the prediction of performance from AI model 844 and summarize the prediction in a report.

In other examples, custom visualization 846 may include a visualization 848 and/or an alert 850. Custom visualization 846 may generate visualization 848 and/or alert 850. For example, if the prediction of performance of equipment 802 include a prediction of poor performance, custom visualization 846 may generate, in response to determining the prediction includes a prediction of poor performance, alert 850 of the prediction. Alert 850 may be transmitted to user device 808 to alert a user that equipment 802 may suffer poor performance. As used herein, a prediction of poor performance may include a prediction of failure of equipment 802, a prediction of required maintenance of equipment 802, a prediction of sub-par operation of equipment 802, a prediction for automatically adjusting operational parameters of equipment 802, and/or a predicted cause and/or time of the poor performance. A user may schedule maintenance of equipment 802 based on alert 850.

In other examples, alert 850 may include a prediction of proper or expected performance of equipment 802.

In another example, if sensed data is collected by sensor package 804 from equipment 802 continuously, custom visualization 846 may generate visualization 840 to include a report summarizing the performance of equipment 802 over a period of time. Custom visualization 846 may generate visualization 840 to include the report summarizing the performance of equipment 802 over a period of time based on the continuously collected sensed data. The report may be a graph or a written report. Visualization 840 may be transmitted to user device 808. A user may schedule maintenance of equipment 802 based on visualization 840.

It will be appreciated that visualization 840 may summarize poor and/or expected performance of equipment 802 over time.

In some implementations, custom visualization 846 may be performed on user device 808, such that visualization 848 and/or alert 850 may be generated on user device 808. For example, user device 808 may receive prediction of performance from AI model 844 and generate visualization 848 and/or alert 850 in response to receiving the prediction of performance of equipment 802.

FIG. 22 depicts a method 900 for monitoring performance of equipment. Method 900 may be performed by system 800.

At step S902, sensed data from a noise sensor is collected at a mobile device. The noise sensor is configured to monitor equipment.

For example, sensed data from noise sensor 820 may be collected at mobile device 808. Noise sensor 820 may be configured to monitor equipment 802.

Equipment 802 may include an HVAC unit, a boiler, a water pipe, an electrical panel, a water heater, a computer server, etc. As well, equipment 802 may be located in an HVAC unit, a manufacturing plant, a cement plant, a transportation vehicle, a retail environment, a telecommunications facility, a mine, agriculture equipment, a residential facility or a warehouse.

Noise sensor 820 may be installed or located in proximity to equipment 802. Noise sensor 820 may record noise data from equipment 802, including noise data in the audible and/or inaudible range from humans.

In some examples, noise sensor 820 may be installed on equipment 802. Noise sensor 820 may be connected to mobile device 808, such as wirelessly or wired. For example, noise sensor 820 may be wirelessly connected to mobile device 808 using Bluetooth, iBeacon, WiFi and/or some other wireless network.

In other examples where noise sensor 820 does not include wireless capabilities or where a wireless connection is not preferred, noise sensor 820 may be physically connected to mobile device 820, such as using a Universal Serial Bus (USB) connector of any type (e.g. a USB Type-C connector), an Ethernet connector, a FireWire™ connector and/or any type of wired connector.

In further examples, noise sensor 820 may be integrated within mobile device 820. For example, noise sensor 820 may be a microphone of mobile device 820.

In some examples, noise sensor 820 may continuously collect sensed data. In other examples, noise sensor 820 may collected sensed data in batches.

Noise sensor 820 may belong to sensor package 804. Sensor package 804 may include one or more other sensors in addition to noise sensor 820. For example, sensor package 804 may include one or more of a noise sensor, a vibration sensor, a temperature sensor, a relative humidity sensor, a gyroscope, a magnetometer, a GPS device, a microphone, a vision, a light sensor, a vibration sensor, a harshness sensor, a pressure sensor, a current sensor, a carbon dioxide sensor, a water leakage sensor, a PIR sensor, a magnetic door sensor, a soil sensor, an air quality sensor, a volatile organic compounds sensor or a particulate matter sensor.

At step S904, the sensed data is received at a machine learning model.

For example, the sensed data may be received at AI model 844. Sensed data may be received by analytics engine 810 from mobile device 806, such as over the Internet or an internal network, over WiFi, Bluetooth and/or some other communication means. Sensor package 804, which may include noise sensor 820 discussed in step S902, may transmit sensed data to mobile device 806.

In some implementations, analytics engine 810 may be hosted in part or in whole on mobile device 806, and so sensed data may be received at analytics engine 810 directly from sensor package 804.

In some further implementations, sensed data may be received by analytics engine 810 and pass through storage 840 and/or processing 842 before AI model 844 receives sensed data. Storage 840 may store sensed data in one or more memories. Processing 842 may perform pre-processing on sensed data, such as filtering, removal of erroneous data, transformation and/or other pre-processing operations.

In further implementations, sensed data may also be transmitted to user device 808 directly from mobile device 806 and/or analytics engine 810.

At step S906, a prediction of the performance of the equipment is received from the machine learning model.

For example, a prediction of the performance of equipment 802 may be received from the machine learning model, such as AI model 844. AI model 844 may generate prediction of performance of equipment 802 based on sensed data received at AI model 844 at step S904.

Prediction of performance may include a prediction of poor performance and/or a prediction of adequate or acceptable performance of equipment 802. Prediction of performance may also include a prediction of failure of equipment 802, a prediction of MTBF of equipment 802, a prediction of required maintenance of equipment 802, a prediction for automatically adjusting operational parameters of equipment 802, and/or a prediction of the health of equipment 802. Prediction of performance may further include a prediction of a time when maintenance of equipment 802 is likely to be required, a likely cause for the predicted failure of equipment 802, and/or a life expectancy of equipment 802 before replacement may be necessary.

Prediction of performance may be received by custom visualization 846 and/or another module or component of analytics engine 810 from AI model 844.

In some examples, prediction of performance may be transmitted to user device 808 without any additional processing. In other examples, prediction of performance may be transmitted to user device 808 with some minor additional processing.

At step S908, the prediction is displayed on a GUI.

In some examples, prediction of performance may be received by user device 808 and displayed on a GUI.

In other examples, user device 808 may access a website, application programming interface (API) or some other portal and view prediction of performance. In the example of a website, prediction of performance may be rendered on a GUI viewable on the website by user device 808.

User device 808 may also render or display prediction of performance using local software, such as a mobile application, computer application or some alternative.

In some examples, prediction of performance may be received by custom visualization 846 from AI model 844. Custom visualization 846 may be executed on a server or on user device 808. Custom visualization 846 may generate a custom visualization of the prediction of performance, which may include one or more metrics related to the prediction of performance of equipment 802. Custom visualization 846 may be configured by user device 808, and may include a graph, a chart, a spreadsheet, a graphic, a pie chart and/or a report. For example, custom visualization 846 may include an LLM configured to interpret the prediction of performance from AI model 844 and summarize the prediction in a report.

Custom visualization 846 may also include a visualization 848 and/or an alert 850. Custom visualization 846 may generate visualization 848 and/or alert 850.

Prediction of performance may include a prediction of poor performance of equipment 802. In some implementations, method 900 may include the additional step of servicing or automatically adjusting equipment 802 in response to a prediction of poor performance by analytics engine 810. Servicing equipment 802 may resolve the predicted poor performance of equipment 802 such that the equipment operates as expected. Automatically adjusting equipment 802, which may include modifying operating parameters of equipment 802, may also resolve the predicted poor performance of equipment 802. In some implementations, analytics engine 810 may automatically schedule an appointment to service equipment 802 in response to a prediction of poor performance of equipment 802.

Any of the steps of method 900 may be performed using other aspects/modules within analytics engine 810, such as those depicted in FIG. 3, FIGS. 4A-4B and FIG. 10 with respect to analytics engine 104, analytics engine 104′ and analytics engine 204, respectively. As noted above, in some implementations, analytics engine 810 may be generally similar or identical to analytics engine 104, analytics engine 104′ and/or analytics engine 204.

Method 900 may perform additional or fewer steps in addition to those discussed above. For example, method 900 may include additional steps of outputting sensed data and/or prediction of performance of equipment 802, which may be provided to user device 808.

In some implementations, a machine learning model (e.g. AI model 844) is hosted in a cloud computing environment, and the sensed data is transmitted from the mobile device to the cloud computing environment over a network for inference.

In other implementations, the machine learning model (e.g. AI model 844) is executed on a mobile device (e.g. mobile device 806), and the inference is performed on-device without transmitting the sensed data to an external server.

In further implementations, a first portion of the machine learning model (e.g. AI model 844) is executed on a mobile device (e.g. mobile device 806) and a second portion is executed in a cloud computing environment, such that partial inference occurs on-device and final inference occurs on the cloud computing environment.

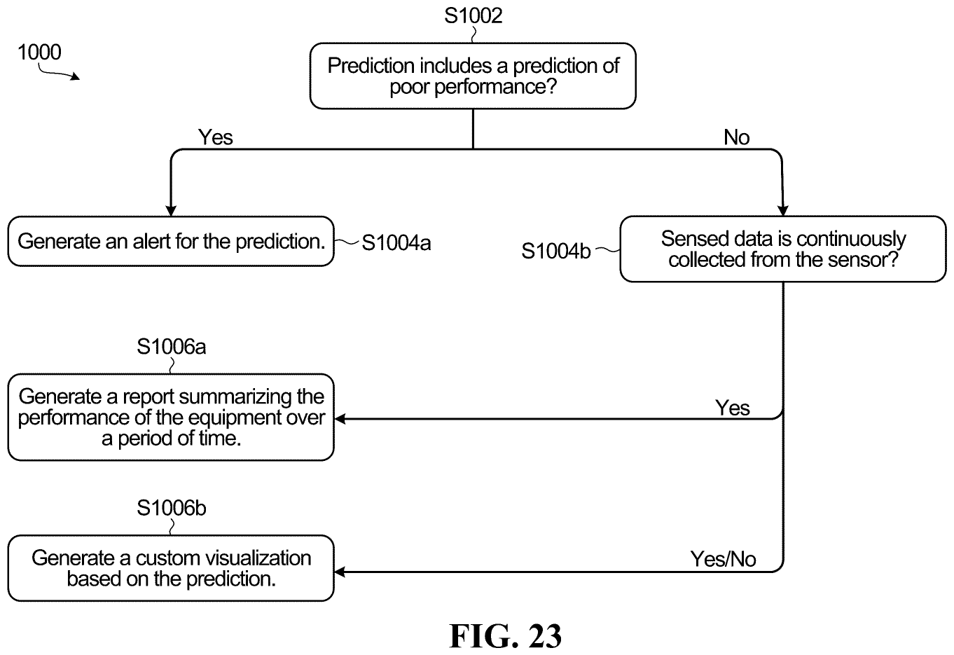

FIG. 23 depicts a method 1000 for performing step S908 of method 900, and in particular for displaying the prediction of performance on a GUI. Method 1000 may be performed by system 800.

At step S1002, it is determined whether the prediction of performance of equipment 802 include a prediction of poor performance.

In some examples, a prediction of poor performance may include a prediction of failure of equipment 802, a prediction of required maintenance of equipment 802, a prediction of sub-par operation of equipment 802, a prediction for automatically adjusting operational parameters of equipment 802, and/or a predicted cause and/or time of the poor performance.

If the prediction includes a prediction of poor performance, at step S1004a an alert may be generated for the prediction of poor performance. For example, alert 850 may be generated and transmitted to user device 808. In other examples where custom visualization 846 is generated on user device 808, alert 850 may be generated by user device 808 and displayed on user device 808. In other examples, alert 850 may be transmitted to other devices, such as to notify a service person that equipment 802 needs maintenance.

If the prediction does not include a prediction of poor performance, method 900 may proceed to step S1004b. At step S1004b it may be determined if sensed data is continuously collected from the sensor. For example, noise sensor 820 and/or other sensors in sensor package 804 may be configured to continuously collect sensed data about equipment 802. Sensed data may be continuously transmitted from noise sensor 820 and/or other sensors in sensor package 804 to mobile device 806 and analytics engine 810. As used herein, the term continuously may mean any one of periodically, in real time, at regular intervals, with consistent delay between collections and/or transmissions of sensed data, and/or in small batches. The term continuously may also include scenarios where sensed data is collected and/or transmitted fairly regularly, with some dropped data samples, some batching, some irregularity in periodicity or sampling intervals, etc.

If the sensed data is determined to be continuously collected from the sensor at step S1004b, method 900 may proceed to step S1006a. At step S1006a, a report summarizing the performance of the equipment over time may be generated. For example, custom visualization 846 may generate visualization 848. Visualization 848 may include a report summarizing the performance of equipment 802 over time. The report may include written text, a graph, a graphic and/or any other method of summarizing the performance of the equipment over time. Custom visualization 846 may include a LLM or some other model or tool.

In other implementations, step S1006a may be performed even if sensed data is not continuously collected. For example, custom visualization 846 may generate visualization 848 even without continuous sensed data. In these implementations, method 900 may skip step S1004b and may not discriminate depending on whether sensed data is continuously collected from the sensor, such as noise sensor 820 and/or any other sensors in sensor package 804.

If sensed data is determined to be continuously collected from the sensor at step S1004b and/or sensed data is determined not to be continuously collected from the sensor at step 1004b, method 900 may perform step S1006b. In implementations where method 900 skips step s1004b, method step S1006b may also be performed regardless of the type of sensed data.

At step S1006b, a custom visualization may be generated based on the prediction. For example, custom visualization 846 may generate visualization 848 based the predicted performance of equipment 802. Visualization 848 may include a graph, report, graphics and any other means to display the predicted performance on a GUI, such as a GUI of user device 808.

It will be understood that in some implementations, one or both of method steps S1006a and S1006b may be performed, such that both method steps s1006a and S1006b may be performed simultaneously. In further implementations, any of method steps S1004a, S1006a and/or S1006b may be performed individually or simultaneously, such that alert 850 and visualization 848 may be generated and displayed on a GUI, such as a GUI of user device 808.

Any of the steps of method 1000 may be performed using other aspects/modules within analytics engine 810, such as those depicted in FIG. 3, FIGS. 4A-4B and FIG. 10 with respect to analytics engine 104, analytics engine 104′ and analytics engine 204, respectively. As noted above, in some implementations, analytics engine 810 may be generally similar or identical to analytics engine 104, analytics engine 104′ and/or analytics engine 204.

Method 1000 may perform additional or fewer steps in addition to those discussed above.

### Computing Device

Components of system 100, system 200 and/or system 800 may be implemented on a computing device, such as analytics engine 104, analytics engine 104′, analytics engine 204, and/or analytics engine 810. Similarly, user device 102, user device 808 and/or mobile device 806. Other components of system 100, system 200 and/or system 800 may also be implemented on a computing device.

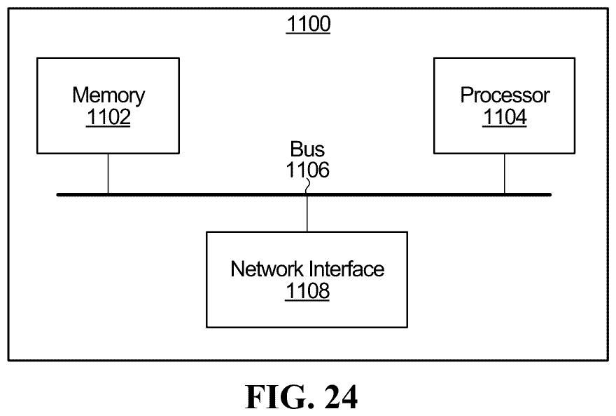

FIG. 24 is a schematic diagram of a computing device 1100 configured to implement the components of system 100, system 200 and/or system 800, according to some implementations. Computing device 1100 includes a memory 1102, a processor 1104 and a bus 1106. Computing device 1100 may also include a network interface 1108. A communication connection is implemented between the memory 1102, the processor 1104, and the network interface 1108 by using the bus 1106.

The processor 1106 and the network interface 1108 are configured to perform, when the program or computer-executable instructions stored in the memory 1102 is/are executed by the processor 1104, steps of method 300, method 400, method 500, method 600, method 700, method 900 and/or method 1000. The processor 1104 and the network interface 1108 may also be configured to perform, when the program or computer-executable instructions stored in the memory 1102 is/are executed by the processor 1104, any other processes or modules discussed with respect to system 100, system 200, system 800, analytics engine 104, analytics engine 104′, analytics engine 204, and/or analytics engine 810, including decision trees 160 and 170.

The memory 1102 may be a read-only memory (Read Only Memory, ROM), a static storage device, a dynamic storage device, or a random access memory (Random Access Memory, RAM). The memory 1102 may store a program or computer-executable instructions. The memory 1102 may be a non-transitory memory.

The processor 1104 may be a general central processing unit (Central Processing Unit, CPU), a microprocessor, an application-specific integrated circuit (Application Specific Integrated Circuit, ASIC), a graphics processing unit (graphics processing unit, GPU), or one or more integrated circuits.

In addition, the processor 1104 may be an integrated circuit chip with a signal processing capability. In an implementation process, steps of method 300, method 400, method 500, method 600, method 700, method 900 and/or method 1000 may be performed by an integrated logical circuit in a form of hardware or by an instruction in a form of software in the processor 1104. In addition, the processor 1102 may be a general purpose processor, a digital signal processor (Digital Signal Processor, DSP), an ASIC, a field programmable gate array (Field Programmable Gate Array, FPGA) or another programmable logic device, a discrete gate or a transistor logic device, or a discrete hardware assembly. The processor 1102 may implement or execute the methods, steps, and logical block diagrams that are disclosed in the example embodiments. The general-purpose processor may be a microprocessor, or the processor may be any conventional processor or the like. The steps of the methods disclosed herein may be directly performed by a hardware decoding processor, or may be performed by using a combination of hardware in the decoding processor and a software module. The software module may be located in a mature storage medium in the art, such as a random access memory, a flash memory, a read-only memory, a programmable read-only memory, an electrically erasable programmable memory, or a register. The storage medium may located in the memory 1102. The processor 1104 may read information from the memory 1104 and complete, by using hardware in the processor 1104, the steps of method 300, method 400, method 500, method 600, method 700, method 900 and/or method 1000.

The network interface 1108 may implement communication between computing device 1100 and one or more other devices and/or computing devices over a communications network, such as by using a transceiver apparatus, for example, including but not limited to a transceiver. For example, components of system 100, system 200 and/or system 800 may be configured to communicate with one another over a communications network. In a particular example, user device 102 and analytics engine 104 may communicate with one another using their own respective network interfaces.

The bus 1106 may include a path that transfers information between all the components of the computing device 1100.

It should be noted that, although only the memory, the processor, and the communications interface are shown in the computing device in FIG. 24, in a specific implementation process, a person skilled in the art should understand that system 100, system 200 and/or system 800, as well as analytics engine 104, analytics engine 104′, analytics engine 204, and/or analytics engine 810, may further include other components that are necessary for implementation, such as one or more additional computing devices, servers, networks, memories, processors, etc. In addition, based on specific needs, a person skilled in the art should understand that the components of these systems may further include hardware components that implement other additional functions. In addition, a person skilled in the art should understand that system 100, system 200 and/or system 800 may include only a component required for implementing the embodiments of the present invention, without a need to include all the components shown in FIG. 24.

The systems and methods described herein may provide a framework for combining ANI, AGI and ASI. This framework may be used to solve systems in multiple domains, and may offer a streamlined solution capable of addressing and solving many problems efficiently across the spectrum of AI capabilities. Compared to existing ANI solutions, which involve custom, cumbersome and time-consuming development, the systems and methods described herein may provide a solution which reduces development time and computing resources spent building tailored solutions to problems. As well, only a single solution deployment may be necessary. Although AGI and ASI currently remain elusive concepts, the systems and methods described herein may also enable the future integration of these AI solutions into a unified system encompassing ANI, AGI and ASI. This framework may be capable of solving a vast array of problems across multiple domains, exhibiting versatility and adaptability compared to existing AI solutions (e.g. ANI). Some of the key problems the system and method described herein may solve include complex decision-making, multitasking across domains, autonomous innovation, enhanced efficiency and productivity, improved personalization, and/or solving global challenges.

The systems and methods described herein may also improve business planning. For example, system 200 and methods 300, 400, 500, 600 and 700 may allow a user to provide limited information describing the business, such as a business name or other descriptive information, and automatically receive a business overview and/or a business plan. AI agents 232 may retrieve further information about the business from environment 106 and generate the business overview and/or business plan with no input or some input from the user. Moreover, the user may provide feedback after the business plan is generated. Feedback may also be obtained from customer feedback and/or one or more performance outcomes of the business after adopting the business plan. The feedback may be input back into system 200 to refine the business overview and/or business plan. In some further implementations, the systems and methods described herein my also include automatically executing the business plan.

In addition to streamlining business plan generation, the systems and methods described herein may provide business planners and executives with a wider variety of information compared to existing methods for generating a business plan. Business plan generation may automatically access information related to competitors, suppliers, the economy and other factors, which may not be as easily obtained without AI assistance.

Furthermore, the systems and methods described herein may also identify improvements to the business which may be achieved by adopting AI and automation at various stages in the business. These improvements may not be readily apparent to businesses, and may lead to a reduction in expenses, increased profitably, improved logistics, improved customer satisfaction and engaged, as well as other tangible business outcomes.

The systems and methods described herein may also improve equipment monitoring and maintenance. For example, faulty equipment may consume more energy than necessary. Equipment which may need maintenance may be discarded and replaced, wasting resources and harming the environment. Equipment in need of specific maintenance may require extensive servicing to diagnose poor performance and identify faulty components. During this time, the equipment may be offline and/or perform inadequately. However, the systems and methods described herein may monitor the equipment over time, learning to identify the baseline and/or adequate performance of the equipment. Deviation from adequate performance may be automatically identified by the systems and methods described herein, and a user may be notified or alerted of any problems with the equipment as soon as they are detected. Resources wasted by faulty equipment may be reduced by the prompt identification and diagnosing of equipment failure or malfunction by the systems and methods described herein. Moreover, specific causes or predicted failure times may be diagnosed or identified by the system or methods described herein, reducing maintenance time spent diagnosing problems. As well, the systems and methods may also provide a diagnostic tool for maintenance staff, who may review previous performance of the equipment over time that was detected and/or analyzed by the systems and methods described herein. As well, rather than replacing equipment or performing maintenance on equipment which is beyond repair, the systems and methods described herein may help identify whether maintenance or replacement is worthwhile.

The systems and methods described herein may provide other improvements which have not been discussed so far, but which may be apparently to a person skilled in the art.

In the several of the example embodiments described herein, it should be understood that the disclosed system and method may be implemented in other manners. For example, the described system embodiment is merely an example. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected according to actual requirements to achieve the objectives of the solutions of the embodiments.

In addition, functional units in the example embodiments may be integrated into one processing unit, or each of the units may exist alone physically, or two or more units are integrated into one unit.

When the functions are implemented in the form of a software functional unit and sold or used as an independent product, the functions may be stored in a non-transitory computer-readable storage medium. Based on such an understanding, the technical solutions of the example embodiments essentially, or the part contributing to the prior art, or some of the technical solutions may be implemented in a form of a software product. The software product is stored in a storage medium, and includes several instructions for instructing a computer device (which may be a personal computer, a server, or a network device) to perform all or some of the steps of the methods described in the example embodiments. The foregoing storage medium includes any medium that can store program code, such as a USB flash drive, a removable hard disk, a read-only memory (Read-Only Memory, ROM), a random access memory (Random Access Memory, RAM), a magnetic disk, or an optical disc.

In the described methods, the boxes may represent events, steps, functions, processes, modules, state-based operations, etc. While some of the above examples have been described as occurring in a particular order, it will be appreciated by persons skilled in the art that some of the steps or processes may be performed in a different order provided that the result of the changed order of any given step will not prevent or impair the occurrence of subsequent steps. Furthermore, some of the messages or steps described above may be removed or combined in other embodiments, and some of the messages or steps described above may be separated into a number of sub-messages or sub-steps in other embodiments. Even further, some or all of the steps may be repeated, as necessary. Elements described as methods or steps similarly apply to systems or subcomponents, and vice-versa. Reference to such words as “sending” or “receiving” could be interchanged depending on the perspective of the particular device, module or logical element.

While some example embodiments have been described, at least in part, in terms of methods, a person of ordinary skill in the art will understand that some example embodiments are also directed to the various components for performing at least some of the aspects and features of the described processes, be it by way of hardware components, software or any combination of the two, or in any other manner. Moreover, some example embodiments are also directed to a pre-recorded storage device or other similar computer-readable medium including program instructions stored thereon for performing the processes described herein. The computer-readable medium includes any non-transient storage medium, such as RAM, ROM, flash memory, compact discs, USB sticks, DVDs, HD-DVDs, or any other such computer-readable memory devices.

It will be understood that the devices described herein include one or more processors and associated memory. The memory may include one or more application program, modules, or other programming constructs containing computer-executable instructions that, when executed by the one or more processors, implement the methods or processes described herein.

The various embodiments presented above are merely examples and are in no way meant to limit the scope of example embodiments. Variations of the innovations described herein will be apparent to persons of ordinary skill in the art, such variations being within the intended scope of the example embodiments. In particular, features from one or more of the above-described embodiments may be selected to create alternative embodiments comprises of a sub-combination of features which may not be explicitly described above. In addition, features from one or more of the above-described embodiments may be selected and combined to create alternative embodiments comprised of a combination of features which may not be explicitly described above. Features suitable for such combinations and sub-combinations would be readily apparent to persons skilled in the art upon review of the example embodiments as a whole. The subject matter described herein intends to cover all suitable changes in technology.

Certain adaptations and modifications of the described embodiments can be made. Therefore, the above discussed embodiments are considered to be illustrative and not restrictive.

What is claimed is:

1. A method for monitoring performance of equipment, the method comprising:
collecting, at a mobile device, sensed data from a noise sensor, wherein the noise sensor is configured to monitor the equipment;
receiving, at a machine learning model, the sensed data; and
receiving, from the machine learning model, a prediction of the performance of the equipment; and
displaying the prediction on a graphical user interface.

2. The method of claim 1, further comprising determining the prediction comprises a prediction of poor performance, and wherein displaying the prediction on the graphical user interface further comprises generating, in response to the determination, an alert for the prediction.

3. The method of claim 1, wherein displaying the prediction on the graphical user interface further comprises generating a custom visualization based on the prediction.

4. The method of claim 1, further comprising collecting, at the mobile device, the sensed data from at least one of a noise sensor, a vibration sensor, a temperature sensor, a relative humidity sensor, a gyroscope, a magnetometer, a global positional system (GPS) device, a microphone, a vision, a light sensor, a vibration sensor, a harshness sensor, a pressure sensor, a current sensor, a carbon dioxide sensor, a water leakage sensor, a passive infrared (PIR) sensor, a magnetic door sensor, a soil sensor, an air quality sensor, a volatile organic compounds sensor or a particulate matter sensor.

5. The method of claim 1, wherein the sensed data from the noise sensor further comprises noise data in the inaudible range for humans.

6. The method of claim 1, further comprising pre-processing the sensed data and receiving, at the machine model, the pre-processed sensed data.

7. The method of claim 1, wherein the machine learning model is re-trained on at least one of the sensed data, the prediction of the performance, or new sensed data collected after the prediction is received from the machine learning model.

8. The method of claim 2, further comprising servicing the equipment or automatically adjusting the equipment in response to the prediction of poor performance.

9. The method of claim 2, wherein the prediction of poor performance is at least one of a prediction of failure of the equipment, a prediction of mean time between failures (MTBF) of the equipment, a prediction of required maintenance of the equipment, a prediction for automatically adjusting operational parameters of the equipment, or a prediction of the health of the equipment.

10. The method of claim 1, further comprising installing the noise sensor on the equipment and connecting the noise sensor to the mobile device.

11. The method of claim 1, wherein the noise sensor is integrated within the mobile device.

12. The method of claim 11, wherein the noise sensor is a microphone of the mobile device.

13. The method of claim 1, wherein the sensed data is continuously collected from the noise sensor.

14. The method of claim 13, wherein displaying the prediction on the graphical user interface further comprises generating a report summarizing the performance of the equipment over a period of time based on the continuously collected sensed data.

15. The method of claim 1, wherein the equipment is located in at least one of a heating, ventilation and air conditioning (HVAC) unit, a manufacturing plant, a cement plant, a transportation vehicle, a retail environment, a telecommunications facility, a mine, agriculture equipment, a residential facility, or a warehouse.

16. The method of claim 1, wherein the machine learning model is hosted in a cloud computing environment, and the sensed data is transmitted from the mobile device to the cloud computing environment over a network for inference.

17. The method of claim 1, wherein the machine learning model is executed on the mobile device, and the inference is performed on-device without transmitting the sensed data to an external server.

18. The method of claim 1, wherein a first portion of the machine learning model is executed on the mobile device and a second portion is executed in a cloud computing environment, such that partial inference occurs on-device and final inference occurs on the cloud computing environment.

19. A system for monitoring performance of equipment, the system comprising:
a memory;
at least one processor to:
collect, at a mobile device, sensed data from a noise sensor, wherein the noise sensor is configured to monitor the equipment;
receive, at a machine learning model, the sensed data; and
receive, from the machine learning model, a prediction of the performance of the equipment; and
display the prediction on a graphical user interface.

20. The system of claim 19, the at least one processor further configured to determine the prediction comprises a prediction of poor performance, and wherein displaying the prediction on the graphical user interface further comprises generating, in response to the determination, an alert for the prediction.

21. The system of claim 19, wherein displaying the prediction on the graphical user interface further comprises generating a custom visualization based on the prediction.

22. The system of claim 19, the at least one processor further configured to collect, at the mobile device, the sensed data from at least one of a noise sensor, a vibration sensor, a temperature sensor, a relative humidity sensor, a gyroscope, a magnetometer, a global positional system (GPS) device, a microphone, a vision, a light sensor, a vibration sensor, a harshness sensor, a pressure sensor, a current sensor, a carbon dioxide sensor, a water leakage sensor, a passive infrared (PIR) sensor, a magnetic door sensor, a soil sensor, an air quality sensor, a volatile organic compounds sensor or a particulate matter sensor.

23. The system of claim 19, wherein the sensed data from the noise sensor further comprises noise data in the inaudible range for humans.

24. The system of claim 19, the at least one processor further configured to pre-process the sensed data and receive, at the machine model, the pre-processed sensed data.

25. The system of claim 19, wherein the machine learning model is re-trained on at least one of the sensed data, the prediction of the performance or new sensed data collected after the prediction is received from the machine learning model.

26. The system of claim 20, the at least one processor further configured to service the equipment or automatically adjust the equipment in response to the prediction of poor performance.

27. The system of claim 20, wherein the prediction of poor performance is at least one of a prediction of failure of the equipment, a prediction of mean time between failures (MTBF) of the equipment, a prediction of required maintenance of the equipment, a prediction for automatically adjusting operational parameters of the equipment, or a prediction of the health of the equipment.

28. The system of claim 19, wherein the noise sensor is installed on the equipment and connected to the mobile device.

29. The system of claim 19, wherein the noise sensor is integrated within the mobile device.

30. The system of claim 29, wherein the noise sensor is a microphone of the mobile device.

31. The system of claim 19, wherein the sensed data is continuously collected from the noise sensor.

32. The system of claim 31, wherein displaying the prediction on the graphical user interface further comprises generating a report summarizing the performance of the equipment over a period of time based on the continuously collected sensed data.

33. The system of claim 19, wherein the equipment is located in at least one of a heating, ventilation and air conditioning (HVAC) unit, a manufacturing plant, a cement plant, a transportation vehicle, a retail environment, a telecommunications facility, a mine, agriculture equipment, a residential facility, or a warehouse.

34. The system of claim 19, wherein the at least one processor is configured to perform inference in a cloud computing environment, and wherein the mobile device transmits the sensed data to the cloud computing environment for analysis.

35. The system of claim 19, wherein the at least one processor is configured to perform inference on the mobile device, such that the machine learning model resides on the mobile device.

36. The system of claim 19, wherein the at least one processor is distributed between an edge device and a cloud computing server, and the instructions cause partial preprocessing on the edge device prior to transmitting the preprocessed data to the cloud computing server for generating the prediction.

37. One or more non-transitory computer readable media storing computer-executable instructions thereon that, when executed by at least one computer, cause the at least one computer to perform a method comprising:
collecting, at a mobile device, sensed data from a noise sensor, wherein the noise sensor is configured to monitor the equipment;
receiving, at a machine learning model, the sensed data; and
receiving, from the machine learning model, a prediction of the performance of the equipment; and
displaying the prediction on a graphical user interface.
